(19) United States
(12) Patent Application Publication
(10) Pub. No.: US 2026/0353169 A1
(43) Pub. Date: Nov. 5, 2026

(54) Packet Burst Information

(71) Applicant: Telefonaktiebolaget LM Ericsson (publ), Stockholm (SE)

(72) Inventors: Fabian de Laval, Täby (SE); Mohammed Yazid Lyazidi, London (GB); Paul Schliwa-Bertling, Ljungsbro (SE); Jose Luis Pradas, Stockholm (SE); Thorsten Lohmar, Aachen (DE)

(21) Appl. No.: 19/101,774

(22) PCT Filed: Aug. 10, 2023
(86) PCT No.: PCT/EP2023/072210

§ 371 Date: Feb. 6, 2025

Related U.S. Application Data
(60) Provisional application No. 63/396,950, filed on Aug. 10, 2022.

(51) Int. Cl. H04W 28/02; H04L 65/65

(52) U.S. Cl. CPC H04W 28/0268; H04L 65/65

(57) ABSTRACT

A method performed by an access network node (14) in an access network of a communication network (10) is disclosed. The access network node (14) receives a burst (30) of packets (32) over a user plane tunnel (22) between the access network node (14) and a user plane network node (16) in a core network of the communication network (10). In some embodiments, a tunnel extension header (40) of at least one of the packets (32) in the burst (30) includes information (36) about the burst (30).

### TECHNICAL FIELD

The present application relates generally to packet burst transmission, and relates more particularly to packet burst transmission in a communication network.

### BACKGROUND

An application server may transmit a burst of packets under some circumstances, e.g., using the Real-time Transport Protocol (RTP), such as for conveying extended Reality (XR) data. Allocating radio resources for the transmission of the burst of packets over a radio interface of a communication network proves challenging, though.

### SUMMARY

According to some embodiments herein, an application server includes information about a burst of packets within a Real-time Transport Protocol (RTP) extension header of at least one of the packets in the burst. The information may include for example information about the size of the burst, the number of packets in the burst, the number of sets of packets in the burst, or the like. Regardless, a user plane network node in the communication network forwards the burst of packets to an access network node, e.g., for transmission over a radio interface. The user plane network node does so by transmitting the burst of packets over a user plane tunnel between the user plane network node and the access network node. Notably, the user plane network node extracts the information about the burst of packets included in the RTP extension header and adds the extracted information in a tunnel extension header of at least one of the packets in the burst. The access network node may then extract the information from the tunnel extension header and exploit the information about the burst for allocating radio resources for transmitting the burst of packets over the radio interface. Some embodiments therefore advantageously improve radio resource allocation in a communication network.

More particularly, embodiments herein include a method performed by an application server. The method comprises generating packets that are to be transmitted in a burst. In some embodiments, said generating includes adding, in a Real-time Transport Protocol, RTP, extension header within at least one of the packets in the burst, information about the burst. The method also comprises transmitting the burst of packets.

In some embodiments, the packets are Internet Protocol, IP, packets.

In some embodiments, the packets each transport an RTP payload.

In some embodiments, the packets each transport an RTP packet with an RTP extension header.

In some embodiments, the information includes burst size information indicating a size of the burst. In some embodiments, the burst size information indicates the size of the burst as being a certain number of bytes or as being within a certain byte number range. In some embodiments, the burst size information indicates the size of the burst by indicating an index into a look-up table or list of different possible burst sizes.

In some embodiments, the information includes packet number information indicating a number of the packets in the burst.

In some embodiments, the packets in the burst comprise one or more sets of packets, wherein each set of packets includes packets carrying respective parts of the same unit of information from an application layer of the application server. In some embodiments, the one or more sets of packets are one or more Protocol Data Unit, PDU, sets, wherein each of the packets is a PDU. In some embodiments, the information includes packet set information indicating how many sets of packets are included in the burst. In some embodiments, the information includes packet set information indicating a number of the one or more sets of packets in the burst. In some embodiments, the information includes packet set size information indicating one or more respective sizes of the one or more sets of packets. In some embodiments, the information includes packet set packet number information indicating, for each of the one or more sets of packets, a number of packets in the set. In some embodiments, the information includes packet set generation timing information. In some embodiments, the packet set generation timing information indicates a difference between times at which successive sets of packets in the burst are generated. In other embodiments, the packet set generation timing information indicates a minimum and maximum difference between times at which successive sets of packets in the burst are generated. In yet other embodiments, the packet set generation timing information indicates, for each pair of successive sets of packets in the burst, a respective difference between times at which the successive sets of packets are generated. In some embodiments, the information includes packet set identity information indicating which packets belong to which sets of packets. In some embodiments, the information includes delay budget information indicating, for each of the one or more sets of packets in the burst, a delay budget for the set of packets. In some embodiments, the information includes packet set importance information indicating, for each of the one or more sets of packets, a level of importance of the set of packets.

In some embodiments, the information includes burst importance information indicating a level of importance of the burst.

In some embodiments, the information includes burst dependence information indicating one or more other bursts of packets on which the burst is dependent.

In some embodiments, transmitting the burst of packets comprises transmitting the burst of packets towards a communication network.

In some embodiments, the packets each carry extended reality, XR, traffic.

In some embodiments, transmitting the burst of packets comprises transmitting the burst of packets by transmitting the packets back-to-back in a burst time interval.

In some embodiments, said generating comprises adding the information about the burst in the RTP extension header within each of the packets in the burst.

In some embodiments, the method further comprises providing user data, and forwarding the user data to a host computer via the transmission to a base station.

Other embodiments herein include a method performed by a network node in a communication network. The method comprises receiving a burst of packets from an application server. In some embodiments, a Real-time Transport Protocol, RTP, extension header within at least one of the packets in the burst includes information about the burst.

In some embodiments, the packets are Internet Protocol, IP, packets.

In some embodiments, the packets each transport an RTP payload.

In some embodiments, the packets each transport an RTP packet with an RTP extension header.

In some embodiments, the information includes burst size information indicating a size of the burst. In some embodiments, the burst size information indicates the size of the burst as being a certain number of bytes or as being within a certain byte number range. In some embodiments, the burst size information indicates the size of the burst by indicating an index into a look-up table or list of different possible burst sizes.

In some embodiments, the information includes packet number information indicating a number of the packets in the burst.

In some embodiments, the packets in the burst comprise one or more sets of packets, wherein each set of packets includes packets carrying respective parts of the same unit of information from an application layer of the application server. In some embodiments, the one or more sets of packets are one or more Protocol Data Unit, PDU, sets, wherein each of the packets is a PDU. In some embodiments, the information includes packet set information indicating how many sets of packets are included in the burst. In some embodiments, the information includes packet set information indicating a number of the one or more sets of packets in the burst. In some embodiments, the information includes packet set size information indicating one or more respective sizes of the one or more sets of packets. In some embodiments, the information includes packet set packet number information indicating, for each of the one or more sets of packets, a number of packets in the set. In some embodiments, the information includes packet set generation timing information. In some embodiments, the packet set generation timing information indicates a difference between times at which successive sets of packets in the burst are generated. In other embodiments, the packet set generation timing information indicates a minimum and maximum difference between times at which successive sets of packets in the burst are generated. In yet other embodiments, the packet set generation timing information indicates, for each pair of successive sets of packets in the burst, a respective difference between times at which the successive sets of packets are generated. In some embodiments, the information includes packet set identity information indicating which packets belong to which sets of packets. In some embodiments, the information includes delay budget information indicating, for each of the one or more sets of packets in the burst, a delay budget for the set of packets. In some embodiments, the information includes packet set importance information indicating, for each of the one or more sets of packets, a level of importance of the set of packets.

In some embodiments, the information includes burst importance information indicating a level of importance of the burst.

In some embodiments, the information includes burst dependence information indicating one or more other bursts of packets on which the burst is dependent.

In some embodiments, the packets each carry extended reality, XR, traffic.

In some embodiments, receiving the burst of packets comprises receiving the packets back-to-back in a burst time interval.

In some embodiments, the information about the burst is included in the RTP extension header within each of the packets in the burst.

In some embodiments, the network node implements a User Plane Function, UPF.

In some embodiments, the network node is a user plane network node in a core network of the communication network.

In some embodiments, the method further comprises forwarding the packets in the burst.

In some embodiments, forwarding the packets comprises forwarding the packets in the burst to an access network node in an access network of the communication network. In some embodiments, forwarding the packets comprises transmitting the packets over a user plane tunnel between the network node and the access network node. In some embodiments, the method further comprises adding the information to a tunnel extension header of at least one of the forwarded packets. In some embodiments, the user plane tunnel is a General Packet Radio Service, GPRS, Tunnelling Protocol, GTP, and the tunnel extension header is a GTP user plane extension header. In some embodiments, the tunnel extension header includes a DL PDU SESSION INFORMATION frame. In some embodiments, the information is added to one or more fields in the DL PDU SESSION INFORMATION frame. In some embodiments, the tunnel extension header includes a DL USER DATA frame. In some embodiments, the information is added to one or more fields in the DL USER DATA frame.

Other embodiments herein include a method performed by a network node in a communication network. The method comprises transmitting a burst of packets over a user plane tunnel between the network node and an access network node in an access network of the communication network. In some embodiments, a tunnel extension header of at least one of the packets in the burst includes information about the burst.

In some embodiments, the packets are Internet Protocol, IP, packets.

In some embodiments, the packets each transport an RTP payload.

In some embodiments, the packets each transport an RTP packet with an RTP extension header.

In some embodiments, the information includes burst size information indicating a size of the burst. In some embodiments, the burst size information indicates the size of the burst as being a certain number of bytes or as being within a certain byte number range. In some embodiments, the burst size information indicates the size of the burst by indicating an index into a look-up table or list of different possible burst sizes.

In some embodiments, the information includes packet number information indicating a number of the packets in the burst.

In some embodiments, the packets in the burst comprise one or more sets of packets, wherein each set of packets includes packets carrying respective parts of the same unit of information from an application layer of the application server. In some embodiments, the one or more sets of packets are one or more Protocol Data Unit, PDU, sets, wherein each of the packets is a PDU. In some embodiments, the information includes packet set information indicating how many sets of packets are included in the burst. In some embodiments, the information includes packet set information indicating a number of the one or more sets of packets in the burst. In some embodiments, the information includes packet set size information indicating one or more respective sizes of the one or more sets of packets. In some embodiments, the information includes packet set packet number information indicating, for each of the one or more sets of packets, a number of packets in the set. In some embodiments, the information includes packet set generation timing information. In some embodiments, the packet set generation timing information indicates a difference between times at which successive sets of packets in the burst are generated. In other embodiments, the packet set generation timing information indicates a minimum and maximum difference between times at which successive sets of packets in the burst are generated. In yet other embodiments, the packet set generation timing information indicates for each pair of successive sets of packets in the burst, a respective difference between times at which the successive sets of packets are generated. In some embodiments, the information includes packet set identity information indicating which packets belong to which sets of packets. In some embodiments, the information includes delay budget information indicating, for each of the one or more sets of packets in the burst, a delay budget for the set of packets. In some embodiments, the information includes packet set importance information indicating, for each of the one or more sets of packets, a level of importance of the set of packets.

In some embodiments, the information includes burst importance information indicating a level of importance of the burst.

In some embodiments, the information includes burst dependence information indicating one or more other bursts of packets on which the burst is dependent.

In some embodiments, the packets each carry extended reality, XR, traffic.

In some embodiments, transmitting the burst of packets comprises transmitting the packets back-to-back in a burst time interval.

In some embodiments, the network node implements a User Plane Function, UPF.

In some embodiments, the user plane tunnel is a General Packet Radio Service, GPRS, Tunnelling Protocol, GTP, and the tunnel extension header is a GTP user plane extension header.

In some embodiments, the tunnel extension header includes a DL PDU SESSION INFORMATION frame. In some embodiments, the information is added to one or more fields in the DL PDU SESSION INFORMATION frame.

In some embodiments, the tunnel extension header includes a DL USER DATA frame. In some embodiments, the information is added to one or more fields in the DL USER DATA frame.

In some embodiments, the method further comprises obtaining user data, and forwarding the user data to a host computer or a communication device.

Other embodiments herein include a method performed by an access network node in an access network of a communication network. The method comprises receiving a burst of packets over a user plane tunnel between the access network node and a user plane network node in a core network of the communication network. In some embodiments, a tunnel extension header of at least one of the packets in the burst includes information about the burst.

In some embodiments, the packets are Internet Protocol, IP, packets.

In some embodiments, the packets each transport an RTP payload.

In some embodiments, the packets each transport an RTP packet with an RTP extension header.

In some embodiments, the information includes burst size information indicating a size of the burst. In some embodiments, the burst size information indicates the size of the burst as being a certain number of bytes or as being within a certain byte number range. In some embodiments, the burst size information indicates the size of the burst by indicating an index into a look-up table or list of different possible burst sizes.

In some embodiments, the information includes packet number information indicating a number of the packets in the burst.

In some embodiments, the packets in the burst comprise one or more sets of packets, wherein each set of packets includes packets carrying respective parts of the same unit of information from an application layer of the application server. In some embodiments, the one or more sets of packets are one or more Protocol Data Unit, PDU, sets, wherein each of the packets is a PDU. In some embodiments, the information includes packet set information indicating how many sets of packets are included in the burst. In some embodiments, the information includes packet set information indicating a number of the one or more sets of packets in the burst. In some embodiments, the information includes packet set size information indicating one or more respective sizes of the one or more sets of packets. In some embodiments, the information includes packet set packet number information indicating, for each of the one or more sets of packets, a number of packets in the set. In some embodiments, the information includes packet set generation timing information. In some embodiments, the packet set generation timing information indicates a difference between times at which successive sets of packets in the burst are generated. In other embodiments, the packet set generation timing information indicates a minimum and maximum difference between times at which successive sets of packets in the burst are generated. In yet other embodiments, the packet set generation timing information indicates, for each pair of successive sets of packets in the burst, a respective difference between times at which the successive sets of packets are generated. In some embodiments, the information includes packet set identity information indicating which packets belong to which sets of packets. In some embodiments, the information includes delay budget information indicating, for each of the one or more sets of packets in the burst, a delay budget for the set of packets. In some embodiments, the information includes packet set importance information indicating, for each of the one or more sets of packets, a level of importance of the set of packets.

In some embodiments, the information includes burst importance information indicating a level of importance of the burst.

In some embodiments, the information includes burst dependence information indicating one or more other bursts of packets on which the burst is dependent.

In some embodiments, the packets each carry extended reality, XR, traffic.

In some embodiments, receiving the burst of packets comprises receiving the packets back-to-back in a burst time interval.

In some embodiments, the network node implements a User Plane Function, UPF.

In some embodiments, the user plane tunnel is a General Packet Radio Service, GPRS, Tunnelling Protocol, GTP, and the tunnel extension header is a GTP user plane extension header.

In some embodiments, the tunnel extension header includes a DL PDU SESSION INFORMATION frame. In some embodiments, the information is added to one or more fields in the DL PDU SESSION INFORMATION frame.

In some embodiments, the tunnel extension header includes a DL USER DATA frame. In some embodiments, the information is added to one or more fields in the DL USER DATA frame.

In some embodiments, the method further comprises, based on the information, allocating radio resources for transmitting the burst of packets over an access link. In some embodiments, said allocating comprises allocating radio resources based on how many packets are included in the burst and/or based on how many sets of packets are included in the burst.

In some embodiments, the method further comprises transmitting the burst of packets over an access link.

### BRIEF DESCRIPTION OF THE DRAWINGS

FIG. 1 illustrates a block diagram of an application server and a communication network according to some embodiments.

FIG. 2 illustrates a block diagram of an application server and a network node according to some embodiments.

FIG. 3 illustrates an RTP header according to some embodiments.

FIG. 4 illustrates an RTP extension header according to some embodiments.

FIG. 5 illustrates a burst containing multiple units of Information according to some embodiments.

FIG. 6 illustrates a burst containing multiple units of Information according to some embodiments.

FIG. 7 illustrates an RTP extension header according to some embodiments.

FIG. 8 illustrates a block diagram of an application server using the RTP protocol with an RTP extension header according to some embodiments.

FIG. 9 is a block diagram of a DL PDU SESSION INFORMATION frame according to some embodiments.

FIG. 10 is a block diagram of a DL USER DATA frame according to some embodiments.

FIG. 11 illustrates a logic flow diagram of a method performed by an application server in accordance with particular embodiments.

FIG. 12 illustrates a logic flow diagram of a method performed by a network node in a communication network in accordance with other particular embodiments.

FIG. 13 illustrates a logic flow diagram of a method performed by a network node in a communication network in accordance with yet other particular embodiments.

FIG. 14 illustrates a logic flow diagram of a method performed by an access network node in an access network of a communication network in accordance with yet other particular embodiments.

FIG. 15 is a block diagram of a communication device according to some embodiments.

FIG. 16 is a block diagram of a network node according to some embodiments.

FIG. 17 is a block diagram of an application server according to some embodiments.

FIG. 18 is a block diagram of a communication system in accordance with some embodiments.

FIG. 19 is a block diagram of a user equipment according to some embodiments.

FIG. 20 is a block diagram of a network node according to some embodiments.

FIG. 21 is a block diagram of a host according to some embodiments.

FIG. 22 is a block diagram of a virtualization environment according to some embodiments.

### DETAILED DESCRIPTION

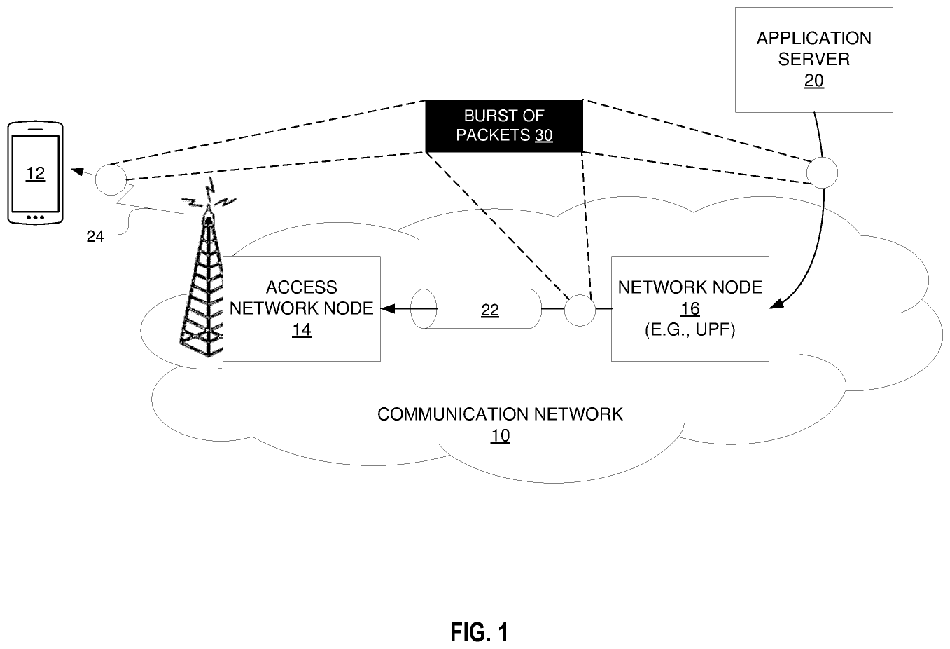

FIG. 1 shows an application server 20 and a communication network 10 according to some embodiments. The application server 20 transmits a burst 30 of packets to the communication network 10. The burst 30 of packets may for instance be packets transmitted back-to-back (in time) within a burst time interval. The packets in the burst 30 in some embodiments transport or convey Real-time Transport Protocol (RTP) data, e.g., as part of conveying extended Reality (XR) application data.

In any event, a network node 16 in the communication network 10 receives this burst 30. The network node 16 may for instance be a user plane network node in a core network of the communication network 10, e.g., implementing a User Plane Function (UPF). The network node 16 forwards the burst 30 of packets to an access network node 14 in an access network of the communication network 10. The network node 16 as shown does so by transmitting the burst 30 of packets over a user plane tunnel 22 between the network node 16 and the access network node 14. The user plane tunnel 22 may for example be a General Packet Radio Service, GPRS, Tunnelling Protocol, GTP, tunnel.

The access network node 14 then transmits the burst 30 of packets over a radio interface 24, e.g., to one or more communication devices 12. The access network node 14 may do so by allocating radio resources for such transmission, e.g., in time, frequency, and/or space domains.

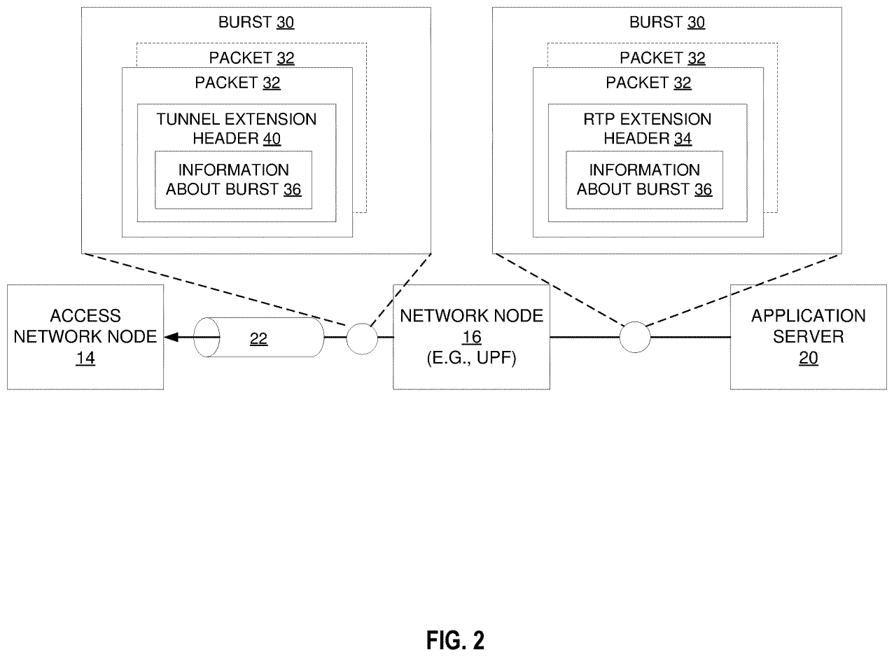

As shown in FIG. 2, some embodiments herein notably convey information 36 about the burst 30 of packets from the application server 20 to the network node 16 and from the network node 16 to the access network node 14. Some embodiments do so as part of equipping the access network node 14 with the information 36 to assist the access network node 14 with radio resource allocation, e.g., for optimally allocating radio resources for transmission of the burst 30.

More particularly in this regard, the application server 20 as shown in FIG. 2 adds information 36 about the burst 30 of packets to an RTP extension header of at least one of the packets 32 in the burst 30. The information 36 may include for example information about the size of the burst 30, the number of packets 32 in the burst 30, the number of sets of packets 32 in the burst 30, etc., as explained more fully below. Regardless, the network node 16 extracts the information 36 from the RTP extension header and propagates the extracted information 36 to a tunnel extension header 40 of at least one of the packets 32 in the burst 30, e.g., a GTP User Plane (GTP-U) extension header. The access network node 14 in turn extracts the information 36 from the tunnel extension header 40 and exploits the information 36 for radio resource allocation.

Some embodiments herein are applicable in the context of XR services, media services, or any other type of service where the Internet Protocol (IP) traffic is inherently periodic, large and latency critical. IP packets in such a case may be highly dependent such that independent treatment of each packet in the access network according to the existing quality of service (QoS) framework is not optimal. In these and other cases, embodiments herein are applicable to a QoS framework that treats packets on a packet set basis instead, e.g., a PDU Set basis as defined below.

Furthermore, some embodiments herein operate on the basis of XR-awareness whereby an application shares traffic information with the access network. In embodiments herein, then, the application server 20 can deliver a combination of both static parameters (parameters which are expected to remain fairly constant throughout an XR session) and dynamic parameters (application information which is given on per packet/PDU Set basis).

### Information Unit

In some embodiments, an application layer instance can produce units of information that can be used by another application layer instance, e.g. to construct usable information and one example of such information unit can be a video frame. Dependent on its size and the maximum transmission unit (MTU) of the transport network, that information unit may need to be segmented and transferred in multiple transport units, e.g. multiple IP packets. When all segments are received, the receiving application layer instance uses the information unit. Hence the quality of experience is dependent on the reception of the information unit rather than individual segments constituting it. Therefore, the forwarding treatment described by the QoS parameters herein may be associated with the information unit.

According to some embodiments, a packet is a Packet Data Unit (PDU) or a Protocol Data Unit (PDU).

### PDU Set

Correspondingly, in some embodiments, a set of packets is a set of PDUs, also referred to as a PDU Set.

PDU Set: In some embodiments, a PDU Set is composed of one or more PDUs carrying the payload of one unit of information generated at the application level (e.g., a frame or video slice for XR and Media (XRM) Services, as used in TR 26.926 V1.1.0). In some implementations, all PDUs in a PDU Set are needed by the application layer to use the corresponding unit of information. In other implementations, the application layer can still recover parts or all of the information unit, event when some PDUs in the PDU Set are missing.

### Dynamic PDU Set Related Parameters

According to some embodiments, dynamic parameters related to the PDU Set may be signaled inside un-encrypted packet headers programmed directly by the application itself. The packet headers may be carried on every packet constituting the PDU Set or only a subset of them. For example, the dynamic PDU Set related information may be carried inside RTP extension headers.

Examples of PDU Set related information may be: (i) PDU sequence number within PDU Set; (ii) PDU Set size i.e., number of bytes contained in the PDU Set; (iii) PDU Set delay information, i.e., information related to when the PDU Set is consumed at the receiving end.

Some embodiments herein particularly concern dynamic PDU Set size information.

### Real Time Transport Protocol

According to some embodiments herein, RTP refers to the RTP protocol specified in RFC 3550 and is a protocol which is used to carry data that has real-time properties used in, for example, audio and video conferencing and live streaming e.g., sports events.

Excerpt from RFC 3550:

Applications typically run RTP on top of the User Datagram Protocol (UDP) to make use of its multiplexing and checksum services; both protocols contribute parts of the transport protocol functionality. However, RTP may be used with other suitable underlying network or transport protocols (see Section 11 in RFC 3550). RTP supports data transfer to multiple destinations using multicast distribution if provided by the underlying network.

Note that RTP itself does not provide any mechanism to ensure timely delivery or provide other quality-of-service guarantees, but relies on lower-layer services to do so. It does not guarantee delivery or prevent out-of-order delivery, nor does it assume that the underlying network is reliable and delivers packets in sequence. The sequence numbers included in RTP allow the receiver to reconstruct the sender's packet sequence, but sequence numbers might also be used to determine the proper location of a packet, for example in video decoding, without necessarily decoding packets in sequence.

While RTP is primarily designed to satisfy the needs of multi-participant multimedia conferences, it is not limited to that particular application. Storage of continuous data, interactive distributed simulation, active badge, and control and measurement applications may also find RTP applicable.

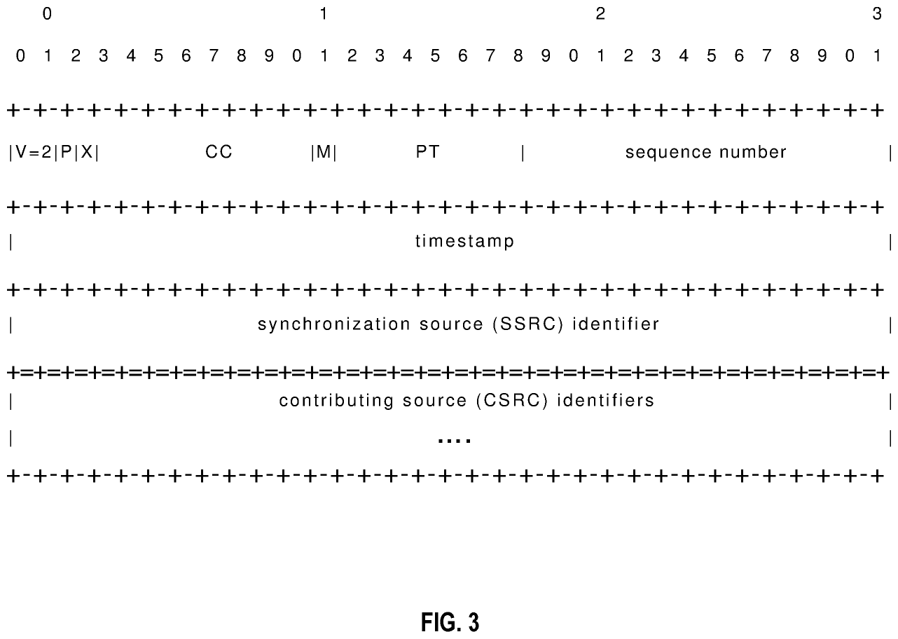

Section 5 in RFC 3550 specifies the RTP header shown in FIG. 3.

Furthermore, RFC 3550 also specifies an extension header that is activated if the extension (X) bit in FIG. 3 is set to 1:
Excerpt from RFC 3550:
extension (X): 1 bit

If the extension bit is set, the fixed header MUST be followed by exactly one header extension, with a format defined in Section 5.3.1 of RFC 3550.

### 5.3.1 RTP Header Extension

An extension mechanism is provided to allow individual implementations to experiment with new payload-format-independent functions that require additional information to be carried in the RTP data packet header. This mechanism is designed so that the header extension may be ignored by other interoperating implementations that have not been extended.

| | | |
|---|---|---|
| Schulzrinne, et al. | Standards Track | [Page 18] |
| RFC 3550 | RTP | July 2003 |

Note that this header extension is intended only for limited use. Most potential uses of this mechanism would be better done another way, using the methods described in the previous section. For example, a profile-specific extension to the fixed header is less expensive to process because it is not conditional nor in a variable location. Additional information required for a particular payload format SHOULD NOT use this header extension, but SHOULD be carried in the payload section of the packet.

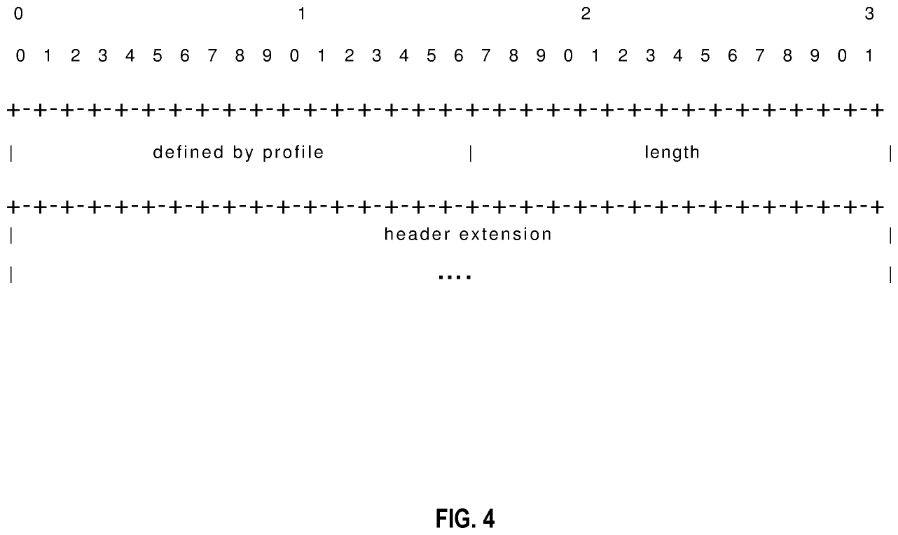

FIG. 4 shows the RTP extension header according to some embodiments.

If the X bit in the RTP header is one, a variable-length header extension MUST be appended to the RTP header, following the contributing source (CSRC) list if present. As shown in FIG. 4, the header extension contains a 16-bit length field that counts the number of 32-bit words in the extension, excluding the four-octet extension header (therefore zero is a valid length). Only a single extension can be appended to the RTP data header. To allow multiple interoperating implementations to each experiment independently with different header extensions, or to allow a particular implementation to experiment with more than one type of header extension, the first 16 bits of the header extension are left open for distinguishing identifiers or parameters. The format of these 16 bits is to be defined by the profile specification under which the implementations are operating.

In some embodiments, the XR application will make use of the RTP protocol described in RFC 3550 for real-time streaming of audio and video XR content. Alternatively or additionally, this protocol will make use of an additional RTP header extension, the content of which is partly defined herein.

In some embodiments, video traffic (IP packets carrying video frames) and potentially audio traffic will be generated in periodic bursts, where a burst can be considered as multiple IP packet sent back-to-back with very short inter-arrival. Such a burst is one example of a burst 30 in FIG. 1. The packets in a burst may or may not be considered as belonging together in the sense that if one packet is lost it renders the rest of them useless.

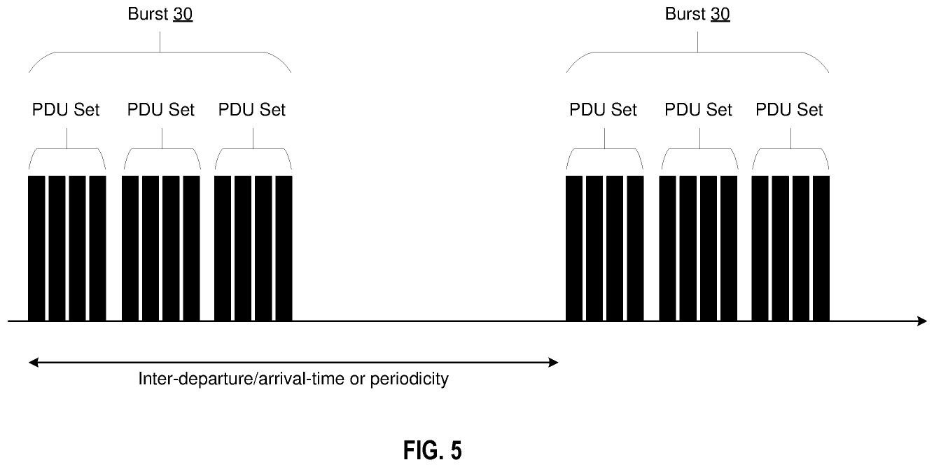

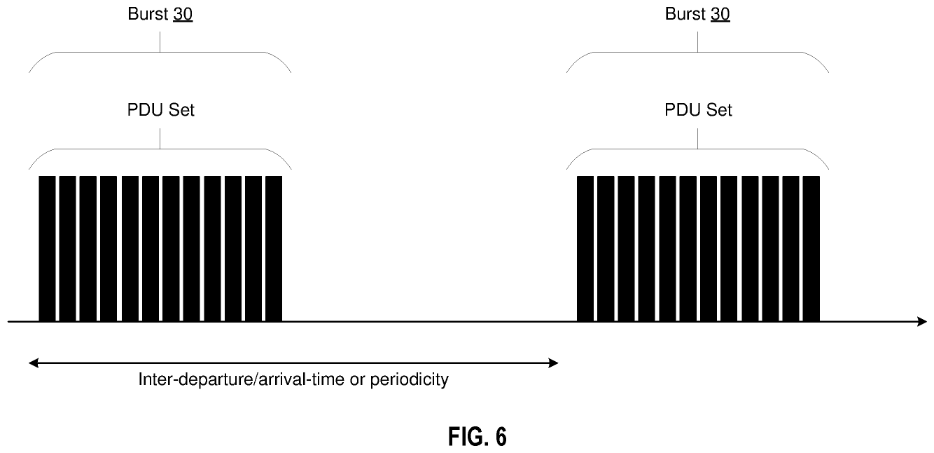

In some embodiments, a burst 30 may constitute multiple units of Information, i.e., a burst 30 may contain multiple PDU Sets. For example, a burst 30 may constitute multiple frames or slices. This is illustrated in FIG. 5 and FIG. 6. FIG. 5 in this regard illustrates an example where each burst 30 contains multiple PDU Sets. FIG. 6 by contrast illustrates an example where each burst 30 contains a single PDU Set.

In some embodiments, all packets within a burst 30 carry the RTP extension header described herein. In other embodiments, though, only a subset of the packets in a burst 30 carry this RTP extension header, e.g., the first IP packet only.

In some embodiments, the application has the necessary information to populate this extension header field.

In some embodiments, with the extra information provided inside the RTP extension header, the 5G Radio Access Network may take more intelligent scheduling decisions yielding higher system capacity.

In some embodiments, the application server 20 may or may not have a direct understanding of the PDU Set concept, meaning the application server 20 may program information directly related to the PDU Set into RTP extension headers or only assistance information which helps the UPF translate the IP packets into PDU Sets.

In some embodiments, the RAN/UPF can receive static assistance information originating from an Application Function (AF) in the core network which can be mapped to a specific QoS flow. The QoS model is detailed in TS 23.501 Section 5.7.

### XR Traffic Characteristics

Some embodiments herein are particularly applicable for conveying XR traffic. XR applications typically generate traffic flows which are in principle periodic, e.g., video traffic with 30, 60, 90, or 120 frames per second (fps). However, the traffic arrival moment at the RAN is affected by jitter around the periodicity value, due to processing of the frames at the application (e.g., for compression) and the capabilities of the platform used by the application, as well as transmission through the Core Network. This is modelled in 3GPP TS 38.415 V17.0.0, by assuming that each data frame arriving at the RAN has a random jitter of [−4; +4] ms (optionally [−5; +5] ms) around the main periodicity. The probability of the jitter value within this interval is given by a truncated Gaussian distribution with mean 0 ms and standard deviation 2 ms.

XR traffic has strict delay requirements, in terms of packet delay budget (PDB). This is the maximum tolerable delay for a packet to be transmitted from a gNB to a user equipment (UE). The PDB value depends on the XR traffic type and is overall between 5 ms and 30 ms.

Some embodiments herein address certain challenge(s) in this context.

The existing RTP protocol does not capture the concept of a PDU Set. Neither does it capture the total size of the packet bursts. If the XR application runs on an un-encrypted RTP protocol as defined by RFC 3550, the User Plane Function (UPF) in the 5G Core has limited ways of extracting useful application information related to the PDU Set.

Hence a solution where application information is directly encoded inside an RTP extension header may be of use for the UPF and subsequently the RAN to perform optimized scheduling.

Certain aspects of the disclosure and their embodiments may provide solutions to these or other challenges. Some embodiments herein include new information related to an IP packet burst (e.g., number of PDU Sets in a burst, number of IP packets and bytes for each PDU set in a burst, time difference generation between PDU sets within the burst, total number bytes and number of IP packets in burst, etc.) inside an RTP extension header. Some embodiments extract the burst information in the UPF and forward the information inside a GTP-U tunnel towards the 5G access network (RAN).

Accordingly, some embodiments provide the new parameters related to the IP packet burst inside an RTP extension and forward the information from 5G Core UPF to and within the 5G access network (RAN). Some embodiments alternatively or additionally provide new static assistance information mapped to a QoS flow.

Some embodiments herein include new information in the Real Time Transport (RTP) Protocol extension header. In one or more such embodiments, the 5G Core Network (CN) extracts that information and forwards it to the access network, e.g., for use by the access network in radio resource allocation, i.e., scheduling.

Certain embodiments may provide one or more of the following technical advantage(s). One advantage is that, with this information present in the RAN, the RAN scheduler may take more intelligent scheduling decisions resulting in higher system capacity.

Also, the new GTP extension header information, by including information of IP packet burst and its dynamic change due to application adaptation, can ensure the NG-RAN is aware of how many packets there are in the PDU set at the beginning of the arrival of the first IP packet, so that the NG-RAN can plan resources in an intelligent way.

### Burst Information

Consider some examples of information 36 about a burst 30 of packets as described in FIG. 2.

In one embodiment, the burst size (as in number of bytes of the burst 30) is included inside an RTP extension header 34. The information 36 may be carried inside a multi-bit field which, directly converted to decimal, indicates the number of bytes of the burst 30.

In a different embodiment, the burst size may be encoded in the RTP extension header 34 with a multi-bit field indicating a row/entry inside a look-up table or list of pre-configured values indicating different burst sizes. One row could for example indicate that the burst size is between X and Y number of bytes.

In a different embodiment, the burst size may be implicitly encoded as a multi-bitfield indicating the number of IP packets in the burst 30. Assuming then that the IP packet size is known or the same for all IP packets of the burst 30, the total burst size may then be deduced. In a different embodiment, the number of PDU Sets within the burst 30 is encoded as an integer in a multibit field.

In a different embodiment, the number of Bytes for each PDU Set within the burst 30 is encoded as several multi-bit fields, each indicating a size for a PDU Set. This information may constitute a list of PDU Set sizes. The size of the list may be indicated by the embodiment described above (number of PDU Sets within burst).

In a different embodiment, the number of IP packets for each PDU Set within the burst 30 is encoded as several multi-bit fields, each indicating the number of IP packets within a PDU Set. This information may constitute a list indicating the said number of IP packets for each PDU Set. The number of PDU Sets may additionally be indicated, or implicitly calculated given the length of the said list. The size of the list may be indicated by the embodiment described above (number of PDU Sets within the burst 30).

In a different embodiment, the PDU Set generation time difference is encoded as several multi-bit fields, each indicating the time difference between the generation of two PDU Sets. It could also indicate a minimum and maximum time difference, or the time difference between each two PDU sets, a first PDU set and the subsequent generated PDU set.

In a different embodiment, a multi-bit field identifying which IP packet belongs to which PDU Set is added. The field may carry the sequence number of the PDU Set it belongs to. For example, a field called PS ID=X can indicate that the IP packet belongs to PDU Set X.

In a different embodiment, a multi-bit field or list of multi-bit fields may indicate the PDU Set delay budget in milliseconds for every PDU Set in the burst 30. The PDU Set delay budget indicates the maximum transit time from the reception of the PDU Set at the N6 interface to the delivery of the PDU set at the UE.

In a different embodiment, a multi-bit field may indicate burst dependence information, i.e., if the content of the burst 30 (all PDU Sets in the burst 30) is dependent upon the successful reception of any prior burst. This field together with an additional multi-bit field indicating the ‘Burst ID’ can be used in RAN to discard un-used bursts. For example, each burst 30 can be assigned a ‘Burst ID’ in the RTP extension header 34. Then a secondary field may indicate the ‘Burst ID’ of which the current burst is dependent upon.

In a different embodiment, a multi-bit field indicates the ‘Importance’ information of each PDU Set. This field may appear as a list of one or more entries indicating the ‘Importance’ of each PDU Set in the burst 30. The ‘importance’ information could for instance be encoded as an integer indicating the priority the PDU Set should have in the RAN scheduler. Having the PDU Set Importance indication separated from the QoS priority allows the RAN scheduler to use the importance information only on a need basis, i.e., in special conditions.

In a different embodiment, a multi-bit field indicating the ‘importance’ of the burst 30 is given in the RTP extension header 34. The field would indicate the same importance for all PDU Sets within the burst 30. The ‘importance’ information could for instance be encoded as an integer indicating the priority that all the PDU Sets of the burst 30 should have in the RAN scheduler. Having the PDU Set Importance indication separated from the QoS priority allows the RAN scheduler to use the importance information only on a need basis, i.e., in special conditions

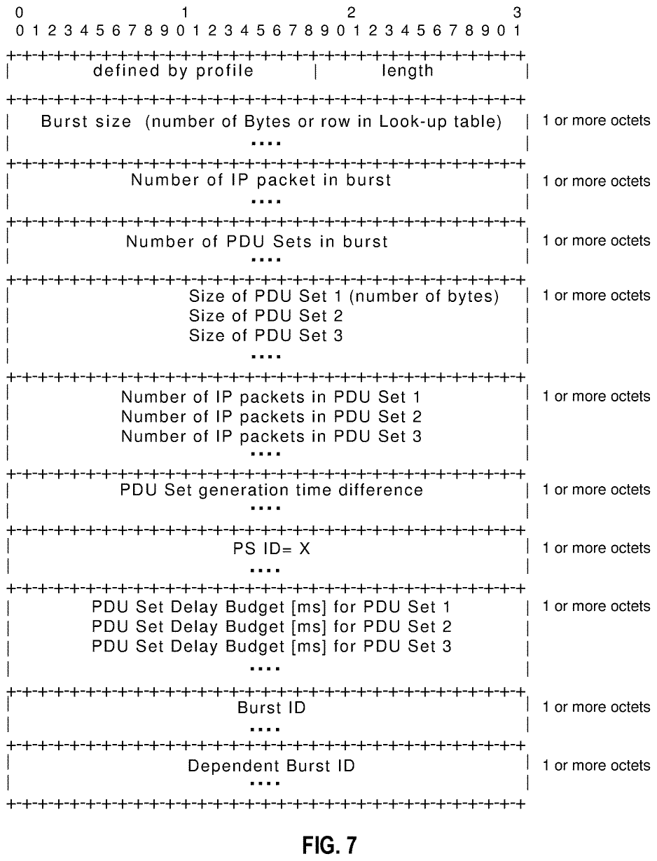

An example of an RTP Extension header 34 capturing the embodiments described above is seen in FIG. 7. The header may include all or only subset of the embodiments. The order of the fields is not considered, and the bit-fields may be arranged differently.

### GTP-U Forwarding

Upon arrival in the 5G Core Network, the UPF is responsible to capture the IP packet bursts and deduce the PDU Set information on the N6 interface. The UPF inspects the RTP extension header 34 and extracts the information 36 about the burst(s) 30. The information 36 is then repackaged inside a GTP-U extension header (as an example of tunnel extension header 40) and forwarded, in-band, inside a GTP-U tunnel on the N3 interface. The 5G radio access network (RAN) receives the PDU Set together with the information 36 on N3. With this information 36, the RAN scheduler may optimizes its resource allocation yielding higher system capacity.

It shall be noted that GTP-Uv1 as specified in TS 29.281 V17.1.0 is used on the N3/NG-U interface between the UPF and the NG-RAN/CU-UP as well as on the F1-U interface between the CU-UP and the DU and the CU-UPs configured with different NG-RAN/gNBs where Xn-U is established. However, the details on the content of the GTP-U headers are specified in TS 38.415 V17.0.0 for the NG-U/N3, and the TS 38.425 V17.0.0 is applicable for the F1-U and XN-U interface.

Application Information as Static Assistance Information Associated with a QoS Flow

In a different embodiment, the ‘PDU Set Importance’ information can be provided as static assistance information associated with a QoS flow. The ‘Importance’ information and how it maps to a specific QoS flow can originate from the Application Function (AF) and forwarded to RAN/UPF. The importance information can be combined with a specific QoS flow. Upon reception of PDU Sets mapped to a specific QoS flow the RAN scheduler may decide whether to consider the importance information for the given PDU Set.

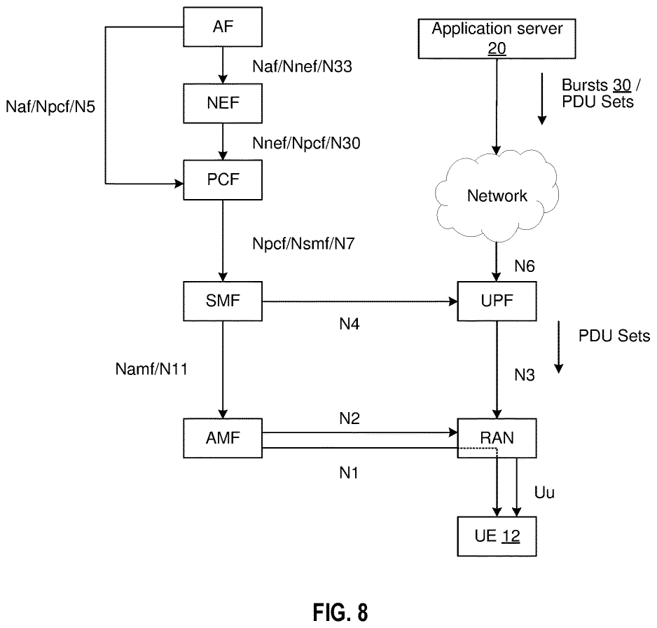

FIG. 8 shows a context in which some embodiments herein are implemented. As shown, the application server 20 generates periodic IP packet bursts (as an example of bursts 30) constituting one or more PDU Sets using the RTP protocol with an RTP extension header 34. The packets are transported across the network. The UPF (as an example of network node 16 in FIG. 1) is configured with the necessary rules and settings to inspect the RTP extension header 34. The UPF receives the IP packets bursts on the N6 interface and inspects the RTP extension header 34. The UPF forwards the ‘burst size’ information 36 inside an GTP-U extension header (as an example of tunnel extension header 40 in FIG. 2) on the N3 interface. The 5G access network (RAN) (representing access network node 14 in FIG. 1) receives the information 36 together with the PDU Set. With the new information 36 provided, the RAN scheduler may increase system capacity.

In the presence of the IP packets burst information 36 in the GTP-U Ext header, it will trigger the endorsement of the information 36 at the receiver. In the case of signalling a changed value from the previous burst information, it means the update of burst information compared to previous received bits.

In one embodiment, the IP packets burst information 36 may be skipped if there is no change or can be always included in every GTP-U header.

A detailed non-limiting example is provided next based on adding one or more fields on the GTP header (as an example of tunnel extension header 40 in FIG. 2) which provides IP packets burst information 36. Using the DL PDU SESSION INFORMATION in TS 38.415 V17.0.0, one example, without loss of generality is as highlighted below, where the DL PDU SESSION INFORMATION is included in a GTP header.

### 5.5.2.1 DL PDU SESSION INFORMATION (PDU Type 0)

This frame format is defined to allow the NG-RAN to receive some control information elements which are associated with the transfer of a packet over the interface.

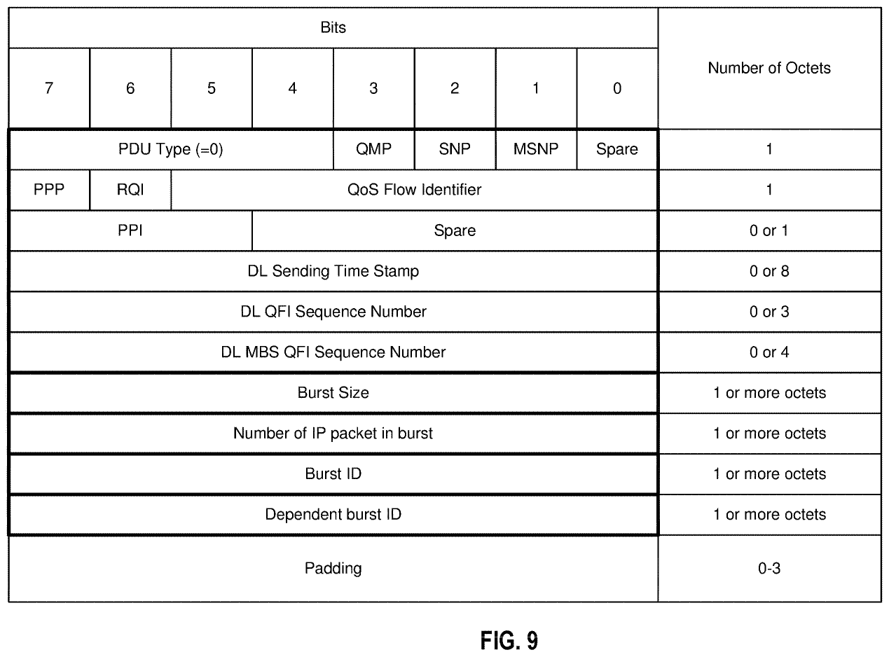

FIG. 9 shows the respective DL PDU SESSION INFORMATION frame that includes information 36 about a burst 30 according to some embodiments, where the information 36 is conveyed via a Burst size field and a Number of IP packet in burst field as described below.
Burst size
Description: This field indicates the presence of Burst Size Information.
Value range: {0 . . . 2ⁿ−1}.
Field length: m bits.
Number of IP packets in burst
Description: When present this parameter indicates the number of IP packet belonging to the burst.
Value range: {0 . . . 2ⁿ−1}.
Field length: m bits.

Using the DL USER DATA frame in TS 38.425 V17.0.0, one example, without loss of generality is as highlighted below:

### 5.5.2.1 DL USER DATA (PDU Type 0)

This frame format is defined e.g. to allow the corresponding node to detect lost NR-U packets and may be associated with the transfer of a Downlink Packet Data Convergence Protocol (PDCP) PDU.

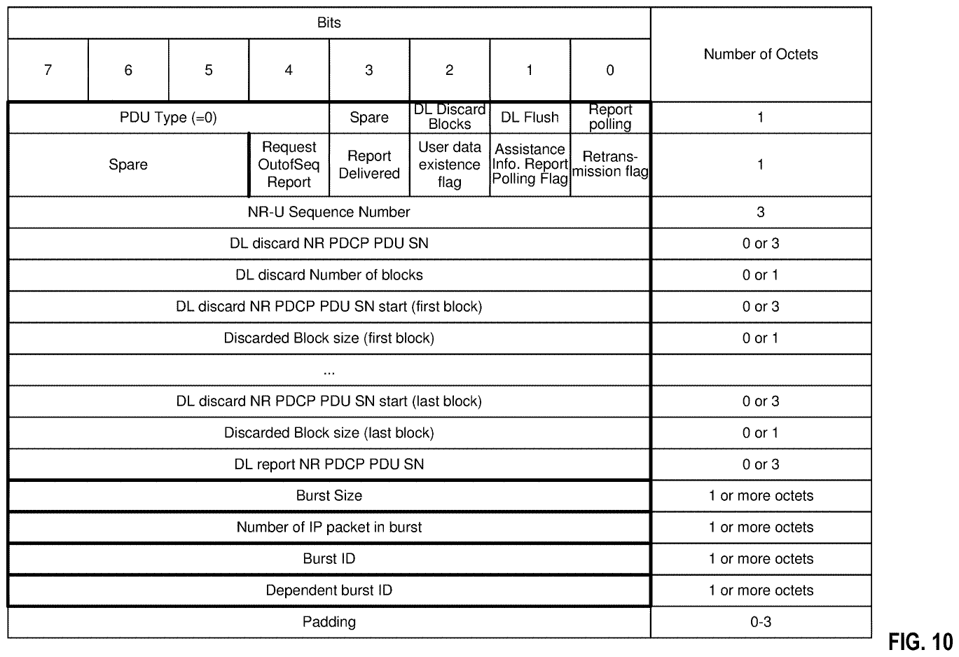

FIG. 10 shows a respective DL USER DATA frame that includes information 36 about a burst 30 according to some embodiments, where the information 36 is conveyed via a Burst size field and a Number of IP packet in burst field as described below.
NOTE 1: All information elements defined in FIG. 10 are also applicable to E-UTRA PDCP. With this understanding, each instance of NR PDCP can be replaced by E-UTRA PDCP.

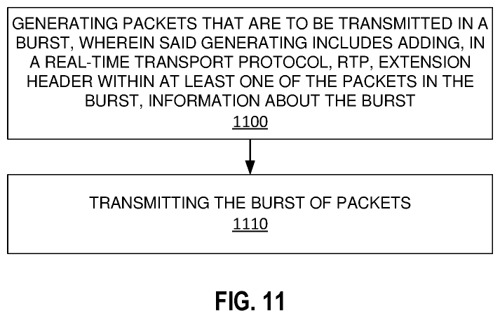

In view of the modifications and variations herein, FIG. 11 depicts a method performed by an application server 20 in accordance with particular embodiments. The method includes generating packets 32 that are to be transmitted in a burst 30 (Block 1100). The step of generating includes adding, in a Real-time Transport Protocol, RTP, extension header 34 within at least one of the packets 32 in the burst 30, information 36 about the burst 30 (Block 1100). The method also includes transmitting the burst 30 of packets (Block 1110).

In some embodiments, the packets 32 are Internet Protocol, IP, packets.

In some embodiments, the packets 32 each transport an RTP payload.

In some embodiments, the packets 32 each transport an RTP packet with an RTP extension header 34.

In some embodiments, the information 36 includes burst size information 36 indicating a size of the burst 30. In some embodiments, the burst size information 36 indicates the size of the burst 30 as being a certain number of bytes or as being within a certain byte number range. In some embodiments, the burst size information 36 indicates the size of the burst 30 by indicating an index into a look-up table or list of different possible burst sizes.

In some embodiments, the information 36 includes packet number information 36 indicating a number of the packets 32 in the burst 30.

In some embodiments, the packets 32 in the burst 30 comprise one or more sets of packets 32, wherein each set of packets 32 includes packets 32 carrying respective parts of the same unit of information from an application layer of the application server 20. In some embodiments, the one or more sets of packets 32 are one or more Protocol Data Unit, PDU, sets, wherein each of the packets 32 is a PDU. In some embodiments, the information 36 includes packet set information 36 indicating how many sets of packets 32 are included in the burst 30. In some embodiments, the information 36 includes packet set information 36 indicating a number of the one or more sets of packets 32 in the burst 30. In some embodiments, the information 36 includes packet set size information 36 indicating one or more respective sizes of the one or more sets of packets 32. In some embodiments, the information 36 includes packet set packet number information 36 indicating, for each of the one or more sets of packets 32, a number of packets 32 in the set. In some embodiments, the information 36 includes packet set generation timing information 36. In some embodiments, the packet set generation timing information 36 indicates a difference between times at which successive sets of packets 32 in the burst 30 are generated. In other embodiments, the packet set generation timing information 36 indicates a minimum and maximum difference between times at which successive sets of packets 32 in the burst 30 are generated. In yet other embodiments, the packet set generation timing information 36 indicates, for each pair of successive sets of packets 32 in the burst 30, a respective difference between times at which the successive sets of packets 32 are generated. In some embodiments, the information 36 includes packet set identity information 36 indicating which packets 32 belong to which sets of packets 32. In some embodiments, the information 36 includes delay budget information 36 indicating, for each of the one or more sets of packets 32 in the burst 30, a delay budget for the set of packets 32. In some embodiments, the information 36 includes packet set importance information 36 indicating, for each of the one or more sets of packets 32, a level of importance of the set of packets 32.

In some embodiments, the information 36 includes burst importance information 36 indicating a level of importance of the burst 30.

In some embodiments, the information 36 includes burst dependence information 36 indicating one or more other bursts of packets 32 on which the burst 30 is dependent.

In some embodiments, transmitting the burst 30 of packets 32 comprises transmitting the burst 30 of packets 32 towards a communication network 10.

In some embodiments, the packets 32 each carry extended reality, XR, traffic.

In some embodiments, transmitting the burst 30 of packets 32 comprises transmitting the burst 30 of packets 32 by transmitting the packets 32 back-to-back in a burst time interval.

In some embodiments, said generating comprises adding the information 36 about the burst 30 in the RTP extension header 34 within each of the packets 32 in the burst 30.

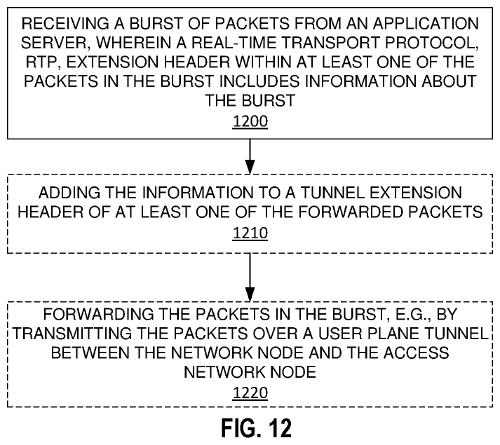

FIG. 12 depicts a method performed by a network node 16 in a communication network 10 in accordance with other particular embodiments. The method includes receiving a burst 30 of packets 32 from an application server 20, wherein a Real-time Transport Protocol, RTP, extension header 34 within at least one of the packets 32 in the burst 30 includes information 36 about the burst 30 (Block 1200).

In some embodiments, the packets 32 are Internet Protocol, IP, packets.

In some embodiments, the packets 32 each transport an RTP payload.

In some embodiments, the packets 32 each transport an RTP packet with an RTP extension header 34.

In some embodiments, the information 36 includes burst size information 36 indicating a size of the burst 30. In some embodiments, the burst size information 36 indicates the size of the burst 30 as being a certain number of bytes or as being within a certain byte number range. In some embodiments, the burst size information 36 indicates the size of the burst 30 by indicating an index into a look-up table or list of different possible burst 30 sizes.

In some embodiments, the information 36 includes packet number information 36 indicating a number of the packets 32 in the burst 30.

In some embodiments, the packets 32 in the burst 30 comprise one or more sets of packets 32, wherein each set of packets 32 includes packets 32 carrying respective parts of the same unit of information 36 from an application layer of the application server 20. In some embodiments, the one or more sets of packets 32 are one or more Protocol Data Unit, PDU, sets, wherein each of the packets 32 is a PDU. In some embodiments, the information 36 includes packet set information 36 indicating how many sets of packets 32 are included in the burst 30. In some embodiments, the information 36 includes packet set information 36 indicating a number of the one or more sets of packets 32 in the burst 30. In some embodiments, the information 36 includes packet set size information 36 indicating one or more respective sizes of the one or more sets of packets 32. In some embodiments, the information 36 includes packet set packet number information 36 indicating, for each of the one or more sets of packets 32, a number of packets 32 in the set. In some embodiments, the information 36 includes packet set generation timing information 36. In some embodiments, the packet set generation timing information 36 indicates a difference between times at which successive sets of packets 32 in the burst 30 are generated. In other embodiments, the packet set generation timing information 36 indicates a minimum and maximum difference between times at which successive sets of packets 32 in the burst 30 are generated. In yet other embodiments, the packet set generation timing information 36 indicates, for each pair of successive sets of packets 32 in the burst 30, a respective difference between times at which the successive sets of packets 32 are generated. In some embodiments, the information 36 includes packet set identity information 36 indicating which packets 32 belong to which sets of packets 32. In some embodiments, the information 36 includes delay budget information 36 indicating, for each of the one or more sets of packets 32 in the burst 30, a delay budget for the set of packets 32. In some embodiments, the information 36 includes packet set importance information 36 indicating, for each of the one or more sets of packets 32, a level of importance of the set of packets 32.

In some embodiments, the information 36 includes burst importance information 36 indicating a level of importance of the burst 30.

In some embodiments, the information 36 includes burst dependence information 36 indicating one or more other bursts of packets 32 on which the burst 30 is dependent.

In some embodiments, the packets 32 each carry extended reality, XR, traffic.

In some embodiments, receiving the burst 30 of packets 32 comprises receiving the packets 32 back-to-back in a burst time interval.

In some embodiments, the information 36 about the burst 30 is included in the RTP extension header 34 within each of the packets 32 in the burst 30.

In some embodiments, the network node 16 implements a User Plane Function, UPF.

In some embodiments, the network node 16 is a user plane network node 16 in a core network of the communication network 10.

In some embodiments, the method also includes forwarding the packets 32 in the burst 30 (Block 1220). For example, in one embodiment, forwarding the packets 32 comprises forwarding the packets 32 in the burst 30 to an access network node 14 in an access network of the communication network 10. For example, in another embodiment, forwarding the packets 32 in the burst 30 comprises transmitting the packets 32 over a user plane tunnel 22 between the network node 16 and the access network node 14. In one such embodiment, the method also includes adding the information 36 to a tunnel extension header 40 of at least one of the forwarded packets 32 (Block 1210).

In some embodiments, the user plane tunnel 22 is a General Packet Radio Service, GPRS, Tunnelling Protocol, GTP, and the tunnel extension header 40 is a GTP user plane extension header. In some embodiments, the tunnel extension header 40 includes a DL PDU SESSION INFORMATION frame. In some embodiments, the information 36 is added to one or more fields in the DL PDU SESSION INFORMATION frame. In some embodiments, the tunnel extension header 40 includes a DL USER DATA frame. In some embodiments, the information 36 is added to one or more fields in the DL USER DATA frame.

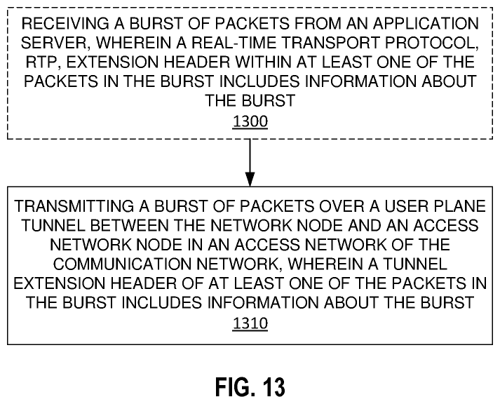

FIG. 13 depicts a method performed by a network node 16 in a communication network 10 in accordance with yet other particular embodiments. The method includes transmitting a burst 30 of packets 32 over a user plane tunnel 22 between the network node 16 and an access network node 14 in an access network of the communication network 10, wherein a tunnel extension header 40 of at least one of the packets 32 in the burst 30 includes information 36 about the burst 30 (Block 1310).

In some embodiments, the method also includes receiving the burst 30 of packets 32 from an application server 20, wherein a Real-time Transport Protocol, RTP, extension header 34 within at least one of the packets 32 in the burst 30 includes information 36 about the burst 30 (Block 1300).

In some embodiments, the packets 32 are Internet Protocol, IP, packets.

In some embodiments, the packets 32 each transport an RTP payload.

In some embodiments, the packets 32 each transport an RTP packet with an RTP extension header 34.

In some embodiments, the information 36 includes burst size information 36 indicating a size of the burst 30. In some embodiments, the burst size information 36 indicates the size of the burst 30 as being a certain number of bytes or as being within a certain byte number range. In some embodiments, the burst size information 36 indicates the size of the burst 30 by indicating an index into a look-up table or list of different possible burst 30 sizes.

In some embodiments, the information 36 includes packet number information 36 indicating a number of the packets 32 in the burst 30.

In some embodiments, the packets 32 in the burst 30 comprise one or more sets of packets 32, wherein each set of packets 32 includes packets 32 carrying respective parts of the same unit of information 36 from an application layer of the application server 20. In some embodiments, the one or more sets of packets 32 are one or more Protocol Data Unit, PDU, sets, wherein each of the packets 32 is a PDU. In some embodiments, the information 36 includes packet set information 36 indicating how many sets of packets 32 are included in the burst 30. In some embodiments, the information 36 includes packet set information 36 indicating a number of the one or more sets of packets 32 in the burst 30. In some embodiments, the information 36 includes packet set size information 36 indicating one or more respective sizes of the one or more sets of packets 32. In some embodiments, the information 36 includes packet set packet number information 36 indicating, for each of the one or more sets of packets 32, a number of packets 32 in the set. In some embodiments, the information 36 includes packet set generation timing information 36. In some embodiments, the packet set generation timing information 36 indicates a difference between times at which successive sets of packets 32 in the burst 30 are generated. In other embodiments, the packet set generation timing information 36 indicates a minimum and maximum difference between times at which successive sets of packets 32 in the burst 30 are generated. In yet other embodiments, the packet set generation timing information 36 indicates for each pair of successive sets of packets 32 in the burst 30, a respective difference between times at which the successive sets of packets 32 are generated. In some embodiments, the information 36 includes packet set identity information 36 indicating which packets 32 belong to which sets of packets 32. In some embodiments, the information 36 includes delay budget information 36 indicating, for each of the one or more sets of packets 32 in the burst 30, a delay budget for the set of packets 32. In some embodiments, the information 36 includes packet set importance information 36 indicating, for each of the one or more sets of packets 32, a level of importance of the set of packets 32.

In some embodiments, the information 36 includes burst importance information 36 indicating a level of importance of the burst 30.

In some embodiments, the information 36 includes burst dependence information 36 indicating one or more other bursts of packets 32 on which the burst 30 is dependent.

In some embodiments, the packets 32 each carry extended reality, XR, traffic.

In some embodiments, transmitting the burst 30 of packets 32 comprises transmitting the packets 32 back-to-back in a burst time interval.

In some embodiments, the network node 16 implements a User Plane Function, UPF.

In some embodiments, the user plane tunnel 22 is a General Packet Radio Service, GPRS, Tunnelling Protocol, GTP, and the tunnel extension header 40 is a GTP user plane extension header.

In some embodiments, the tunnel extension header 40 includes a DL PDU SESSION INFORMATION frame. In some embodiments, the information 36 is added to one or more fields in the DL PDU SESSION INFORMATION frame.

In some embodiments, the tunnel extension header 40 includes a DL USER DATA frame. In some embodiments, the information 36 is added to one or more fields in the DL USER DATA frame.

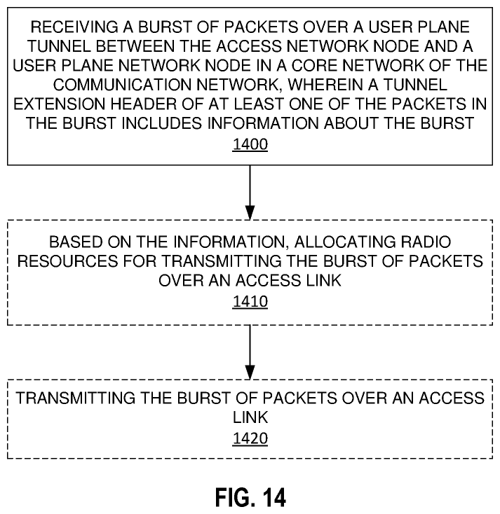

FIG. 14 depicts a method performed by an access network node 14 in an access network of a communication network 10 in accordance with yet other particular embodiments. The method includes receiving a burst 30 of packets 32 over a user plane tunnel 22 between the access network node 14 and a user plane network node 16 in a core network of the communication network 10, wherein a tunnel extension header 40 of at least one of the packets 32 in the burst 30 includes information 36 about the burst 30 (Block 1400).

In some embodiments, the packets 32 are Internet Protocol, IP, packets.

In some embodiments, the packets 32 each transport an RTP payload.

In some embodiments, the packets 32 each transport an RTP packet with an RTP extension header 34.

In some embodiments, the information 36 includes burst size information 36 indicating a size of the burst 30. In some embodiments, the burst size information 36 indicates the size of the burst 30 as being a certain number of bytes or as being within a certain byte number range. In some embodiments, the burst size information 36 indicates the size of the burst 30 by indicating an index into a look-up table or list of different possible burst 30 sizes.

In some embodiments, the information 36 includes packet number information 36 indicating a number of the packets 32 in the burst 30.

In some embodiments, the packets 32 in the burst 30 comprise one or more sets of packets 32, wherein each set of packets 32 includes packets 32 carrying respective parts of the same unit of information from an application layer of the application server 20. In some embodiments, the one or more sets of packets 32 are one or more Protocol Data Unit, PDU, sets, wherein each of the packets 32 is a PDU. In some embodiments, the information 36 includes packet set information 36 indicating how many sets of packets 32 are included in the burst 30. In some embodiments, the information 36 includes packet set information 36 indicating a number of the one or more sets of packets 32 in the burst 30. In some embodiments, the information 36 includes packet set size information 36 indicating one or more respective sizes of the one or more sets of packets 32. In some embodiments, the information 36 includes packet set packet number information 36 indicating, for each of the one or more sets of packets 32, a number of packets 32 in the set. In some embodiments, the information 36 includes packet set generation timing information 36. In some embodiments, the packet set generation timing information 36 indicates a difference between times at which successive sets of packets 32 in the burst 30 are generated. In other embodiments, the packet set generation timing information 36 indicates a minimum and maximum difference between times at which successive sets of packets 32 in the burst 30 are generated. In yet other embodiments, the packet set generation timing information 36 indicates, for each pair of successive sets of packets 32 in the burst 30, a respective difference between times at which the successive sets of packets 32 are generated. In some embodiments, the information 36 includes packet set identity information 36 indicating which packets 32 belong to which sets of packets 32. In some embodiments, the information 36 includes delay budget information 36 indicating, for each of the one or more sets of packets 32 in the burst 30, a delay budget for the set of packets 32. In some embodiments, the information 36 includes packet set importance information 36 indicating, for each of the one or more sets of packets 32, a level of importance of the set of packets 32.

In some embodiments, the information 36 includes burst importance information 36 indicating a level of importance of the burst 30.

In some embodiments, the information 36 includes burst dependence information 36 indicating one or more other bursts of packets 32 on which the burst 30 is dependent.

In some embodiments, the packets 32 each carry extended reality, XR, traffic.

In some embodiments, receiving the burst 30 of packets 32 comprises receiving the packets 32 back-to-back in a burst time interval.

In some embodiments, the network node 16 implements a User Plane Function, UPF.

In some embodiments, the user plane tunnel 22 is a General Packet Radio Service, GPRS, Tunnelling Protocol, GTP, and the tunnel extension header 40 is a GTP user plane extension header.

In some embodiments, the tunnel extension header 40 includes a DL PDU SESSION INFORMATION frame. In some embodiments, the information 36 is added to one or more fields in the DL PDU SESSION INFORMATION frame.

In some embodiments, the tunnel extension header 40 includes a DL USER DATA frame. In some embodiments, the information 36 is added to one or more fields in the DL USER DATA frame.

In some embodiments, the method also comprises, based on the information 36, allocating radio resources for transmitting the burst 30 of packets 32 over an access link 24 (Block 1410).

In some embodiments, the method further comprises transmitting the burst 30 of packets 32 over an access link 24 (Block 1420).

Embodiments herein also include corresponding apparatuses. Embodiments herein for instance include an application server 20 configured to perform any of the steps of any of the embodiments described above for the application server 20.

Embodiments also include an application server 20 comprising processing circuitry and power supply circuitry. The processing circuitry is configured to perform any of the steps of any of the embodiments described above for the application server 20. The power supply circuitry is configured to supply power to the application server 20.

Embodiments further include an application server 20 comprising processing circuitry. The processing circuitry is configured to perform any of the steps of any of the embodiments described above for the application server 20. In some embodiments, the application server 20 further comprises communication circuitry.

Embodiments further include an application server 20 comprising processing circuitry and memory. The memory contains instructions executable by the processing circuitry whereby the application server 20 is configured to perform any of the steps of any of the embodiments described above for the application server 20.

Embodiments herein also include a network node 16 configured to perform any of the steps of any of the embodiments described above for the network node 16.

Embodiments also include a network node 16 comprising processing circuitry and power supply circuitry. The processing circuitry is configured to perform any of the steps of any of the embodiments described above for the network node 16. The power supply circuitry is configured to supply power to the network node 16.

Embodiments further include a network node 16 comprising processing circuitry. The processing circuitry is configured to perform any of the steps of any of the embodiments described above for the network node 16. In some embodiments, the network node 16 further comprises communication circuitry.

Embodiments further include a network node 16 comprising processing circuitry and memory. The memory contains instructions executable by the processing circuitry whereby the network node 16 is configured to perform any of the steps of any of the embodiments described above for the network node 16.

Embodiments herein also include an access network node 14 configured to perform any of the steps of any of the embodiments described above for the access network node 14.

Embodiments also include an access network node 14 comprising processing circuitry and power supply circuitry. The processing circuitry is configured to perform any of the steps of any of the embodiments described above for the access network node 14. The power supply circuitry is configured to supply power to the access network node 14.

Embodiments further include an access network node 14 comprising processing circuitry. The processing circuitry is configured to perform any of the steps of any of the embodiments described above for the access network node 14. In some embodiments, the access network node 14 further comprises communication circuitry.

Embodiments further include an access network node 14 comprising processing circuitry and memory. The memory contains instructions executable by the processing circuitry whereby the access network node 14 is configured to perform any of the steps of any of the embodiments described above for the access network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

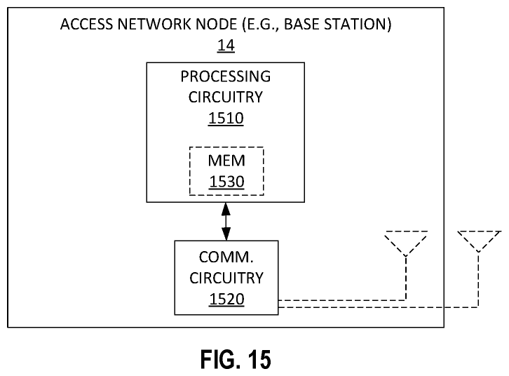

FIG. 15 for example illustrates an access network node 14 as implemented in accordance with one or more embodiments. As shown, the access network node 14 includes processing circuitry 1510 and communication circuitry 1520. The communication circuitry 1520 (e.g., radio circuitry) is configured to transmit and/or receive information to and/or from one or more other nodes, e.g., via any communication technology. Such communication may occur via one or more antennas that are either internal or external to the access network node 1500. The processing circuitry 1510 is configured to perform processing described above, e.g., in FIG. 14, such as by executing instructions stored in memory 1530. The processing circuitry 1510 in this regard may implement certain functional means, units, or modules.

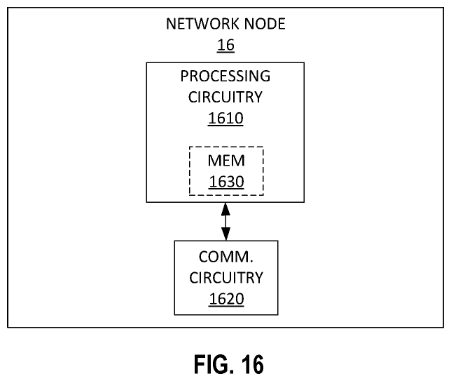

FIG. 16 illustrates a network node 16 as implemented in accordance with one or more embodiments. As shown, the network node 16 includes processing circuitry 1610 and communication circuitry 1620. The communication circuitry 1620 is configured to transmit and/or receive information to and/or from one or more other nodes, e.g., via any communication technology. The processing circuitry 1610 is configured to perform processing described above, e.g., in FIGS. 12 and/or 13, such as by executing instructions stored in memory 1630. The processing circuitry 1610 in this regard may implement certain functional means, units, or modules.

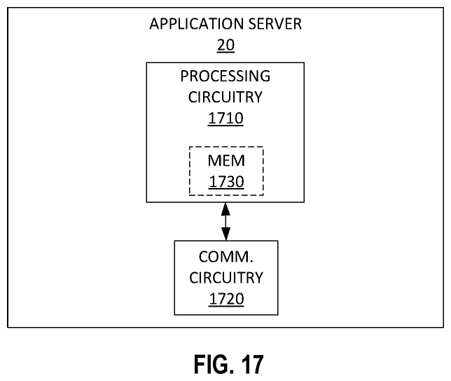

FIG. 17 illustrates an application server 20 as implemented in accordance with one or more embodiments. As shown, the application server 20 includes processing circuitry 1710 and communication circuitry 1720. The communication circuitry 1720 is configured to transmit and/or receive information to and/or from one or more other nodes, e.g., via any communication technology. The processing circuitry 1710 is configured to perform processing described above, e.g., in FIG. 11, such as by executing instructions stored in memory 1730. The processing circuitry 1710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

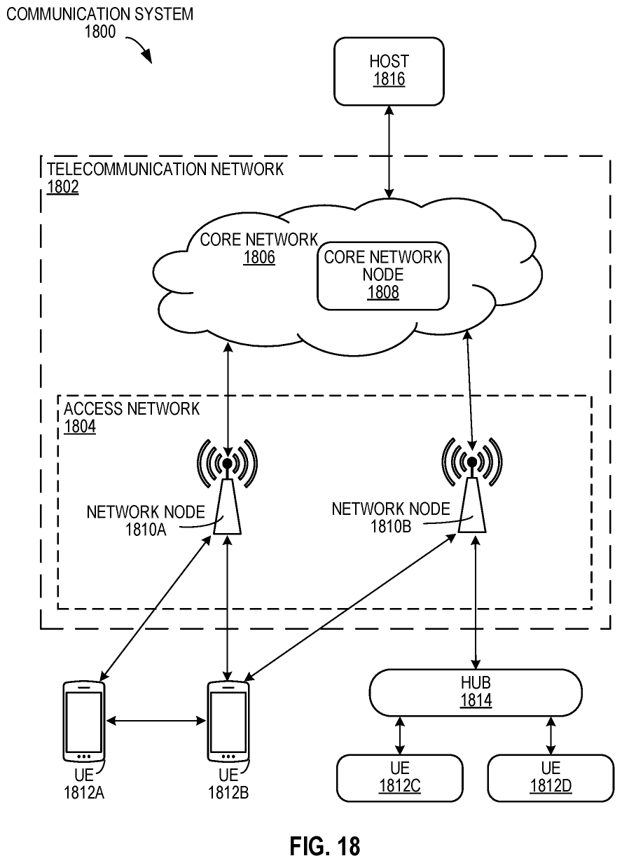

FIG. 18 shows an example of a communication system 1800 in accordance with some embodiments.

In the example, the communication system 1800 includes a telecommunication network 1802 that includes an access network 1804, such as a radio access network (RAN), and a core network 1806, which includes one or more core network nodes 1808. The access network 1804 includes one or more access network nodes, such as network nodes 1810a and 1810b (one or more of which may be generally referred to as network nodes 1810), or any other similar 3rd Generation Partnership Project (3GPP) access node or non-3GPP access point. The network nodes 1810 facilitate direct or indirect connection of user equipment (UE), such as by connecting UEs 1812a, 1812b, 1812c, and 1812d (one or more of which may be generally referred to as UEs 1812) to the core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1802 is a cellular network that implements 3GPP standardized features. Accordingly, the telecommunications network 1802 may support network slicing to provide different logical networks to different devices that are connected to the telecommunication network 1802. For example, the telecommunications network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1814 communicates with the access network 1804 to facilitate indirect communication between one or more UEs (e.g., UE 1812c and/or 1812d) and network nodes (e.g., network node 1810b). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a VR headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810b. The hub 1814 may also allow for a different communication scheme and/or schedule between the hub 1814 and UEs (e.g., UE 1812c and/or 1812d), and between the hub 1814 and the core network 1806. In other examples, the hub 1814 is connected to the core network 1806 and/or one or more UEs via a wired connection. Moreover, the hub 1814 may be configured to connect to an M2M service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810b. In other embodiments, the hub 1814 may be a non-dedicated hub—that is, a device which is capable of operating to route communications between the UEs and network node 1810b, but which is additionally capable of operating as a communication start and/or end point for certain data channels.

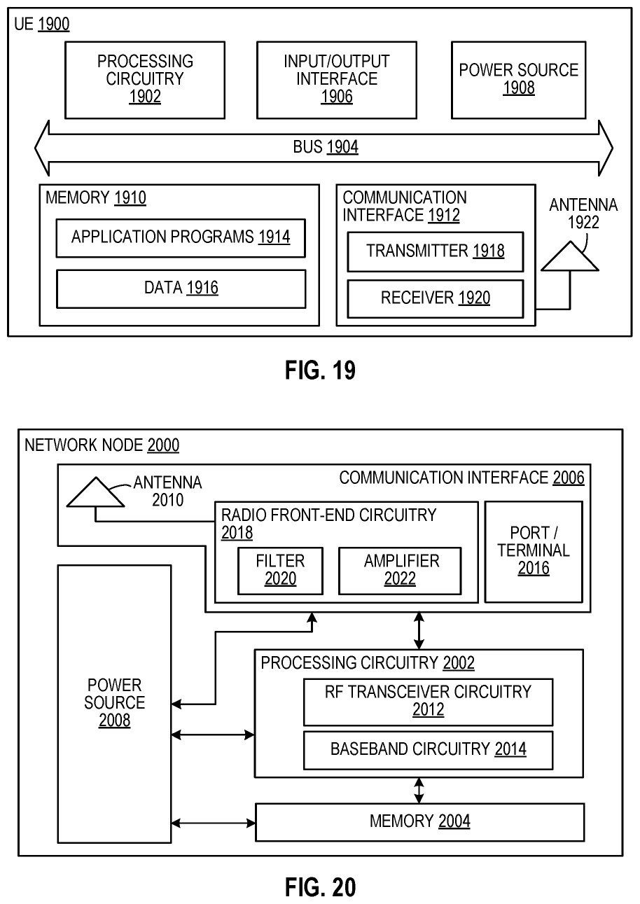

FIG. 19 shows a UE 1900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1902 may include multiple central processing units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging of the power source 1908. Power circuitry may perform any formatting, converting, or other modification to the power from the power source 1908 to make the power suitable for the respective components of the UE 1900 to which power is supplied.

The memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1910 may allow the UE 1900 to access instructions, application programs and the like, stored on transitory or non-transitory memory media, to off-load data, or to upload data. An article of manufacture, such as one utilizing a communication system may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., antenna 1922) and may share circuit components, software or firmware, or alternatively be implemented separately.

In the illustrated embodiment, communication functions of the communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node 2000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes a processing circuitry 2002, a memory 2004, a communication interface 2006, and a power source 2008. The network node 2000 may be composed of multiple physically separate components (e.g., a NodeB component and a RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, to provide network node 2000 functionality.

In some embodiments, the processing circuitry 2002 includes a system on a chip (SOC). In some embodiments, the processing circuitry 2002 includes one or more of radio frequency (RF) transceiver circuitry 2012 and baseband processing circuitry 2014. In some embodiments, the radio frequency (RF) transceiver circuitry 2012 and the baseband processing circuitry 2014 may be on separate chips (or sets of chips), boards, or units, such as radio units and digital units. In alternative embodiments, part or all of RF transceiver circuitry 2012 and baseband processing circuitry 2014 may be on the same chip or set of chips, boards, or units.

The memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. Radio front-end circuitry 2018 comprises filters 2020 and amplifiers 2022. The radio front-end circuitry 2018 may be connected to an antenna 2010 and processing circuitry 2002. The radio front-end circuitry may be configured to condition signals communicated between antenna 2010 and processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of filters 2020 and/or amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface may comprise different components and/or different combinations of components.

In certain alternative embodiments, the network node 2000 does not include separate radio front-end circuitry 2018, instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes one or more ports or terminals 2016, the radio front-end circuitry 2018, and the RF transceiver circuitry 2012, as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, communication interface 2006, and/or the processing circuitry 2002 may be configured to perform any receiving operations and/or certain obtaining operations described herein as being performed by the network node. Any information, data and/or signals may be received from a UE, another network node and/or any other network equipment. Similarly, the antenna 2010, the communication interface 2006, and/or the processing circuitry 2002 may be configured to perform any transmitting operations described herein as being performed by the network node. Any information, data and/or signals may be transmitted to a UE, another network node and/or any other network equipment.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

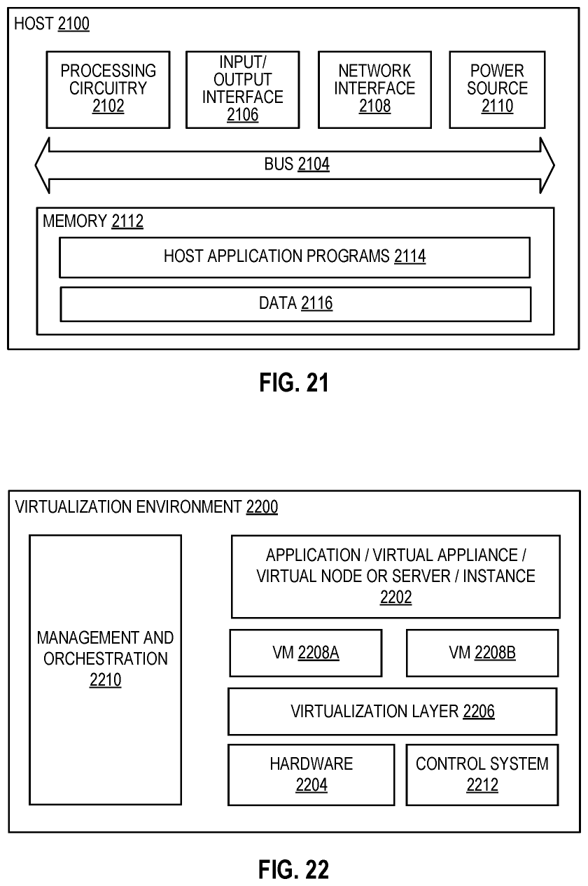

FIG. 21 is a block diagram of a host 2100, which may be an embodiment of the host 1816 of FIG. 18, in accordance with various aspects described herein. As used herein, the host 2100 may be or comprise various combinations hardware and/or software, including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and a memory 2112. Other components may be included in other embodiments. Features of these components may be substantially similar to those described with respect to the devices of previous figures, such as FIGS. 19 and 20, such that the descriptions thereof are generally applicable to the corresponding components of host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (WVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for over-the-top services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or virtual machine monitors (VMMs)), provide VMs 2208a and 2208b (one or more of which may be generally referred to as VMs 2208), and/or perform any of the functions, features and/or benefits described in relation with some embodiments described herein. The virtualization layer 2206 may present a virtual operating platform that appears like networking hardware to the VMs 2208.

The VMs 2208 comprise virtual processing, virtual memory, virtual networking or interface and virtual storage, and may be run by a corresponding virtualization layer 2206. Different embodiments of the instance of a virtual appliance 2202 may be implemented on one or more of VMs 2208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2208 may be a software implementation of a physical machine that runs programs as if they were executing on a physical, non-virtualized machine. Each of the VMs 2208, and that part of hardware 2204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2208 on top of the hardware 2204 and corresponds to the application 2202.

Hardware 2204 may be implemented in a standalone network node with generic or specific components. Hardware 2204 may implement some functions via virtualization. Alternatively, hardware 2204 may be part of a larger cluster of hardware (e.g. such as in a data center or CPE) where many hardware nodes work together and are managed via management and orchestration 2210, which, among others, oversees lifecycle management of applications 2202. In some embodiments, hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2212 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some embodiments herein are enumerated as below:

### Group A Embodiments

A1. A method performed by an application server, the method comprising:
   generating packets that are to be transmitted in a burst, wherein said generating includes adding, in a Real-time Transport Protocol, RTP, extension header within at least one of the packets in the burst, information about the burst; and transmitting the burst of packets.
   A2. The method of embodiment A1, wherein the packets are Internet Protocol, IP, packets.
A3. The method of any of embodiments A1-A2, wherein the packets each transport an RTP payload.
A4. The method of any of embodiments A1-A3, wherein the packets each transport an RTP packet with an RTP extension header.
A5. The method of any of embodiments A1-A4, wherein the information includes burst size information indicating a size of the burst.
A6. The method of embodiment A5, wherein the burst size information indicates the size of the burst as being a certain number of bytes or as being within a certain byte number range.
A7. The method of embodiment A5, wherein the burst size information indicates the size of the burst by indicating an index into a look-up table or list of different possible burst sizes.
A8. The method of any of embodiments A1-A7, wherein the information includes packet number information indicating a number of the packets in the burst.
A9. The method of any of embodiments A1-A8, wherein the packets in the burst comprise one or more sets of packets, wherein each set of packets includes packets carrying respective parts of the same unit of information from an application layer of the application server.
A10. The method of embodiment A9, wherein the one or more sets of packets are one or more Protocol Data Unit, PDU, sets, wherein each of the packets is a PDU.
A11. The method of any of embodiments A9-A10, wherein the information includes packet set information indicating how many sets of packets are included in the burst.
A12. The method of any of embodiments A9-A11, wherein the information includes packet set information indicating a number of the one or more sets of packets in the burst.
A13. The method of any of embodiments A9-A12, wherein the information includes packet set size information indicating one or more respective sizes of the one or more sets of packets.
A14. The method of any of embodiments A9-A13, wherein the information includes packet set packet number information indicating, for each of the one or more sets of packets, a number of packets in the set.
A15. The method of any of embodiments A9-A14, wherein the information includes packet set generation timing information indicating:
   a difference between times at which successive sets of packets in the burst are generated; or
   a minimum and maximum difference between times at which successive sets of packets in the burst are generated; or
   for each pair of successive sets of packets in the burst, a respective difference between times at which the successive sets of packets are generated; or
A16. The method of any of embodiments A9-A15, wherein the information includes packet set identity information indicating which packets belong to which sets of packets.
A17. The method of any of embodiments A9-A16, wherein the information includes delay budget information indicating, for each of the one or more sets of packets in the burst, a delay budget for the set of packets.
A18. The method of any of embodiments A9-A17, wherein the information includes packet set importance information indicating, for each of the one or more sets of packets, a level of importance of the set of packets.
A19. The method of any of embodiments A1-A18, wherein the information includes burst importance information indicating a level of importance of the burst.
A20. The method of any of embodiments A1-A19, wherein the information includes burst dependence information indicating one or more other bursts of packets on which the burst is dependent.
A21. The method of any of embodiments A1-A20, wherein transmitting the burst of packets comprises transmitting the burst of packets towards a communication network.
A22. The method of any of embodiments A1-A21, wherein the packets each carry extended reality, XR, traffic.
A23. The method of any of embodiments A1-A22, wherein transmitting the burst of packets comprises transmitting the burst of packets by transmitting the packets back-to-back in a burst time interval.
A24. The method of any of embodiments A1-A23, wherein said generating comprises adding the information about the burst in the RTP extension header within each of the packets in the burst.
AA. The method of any of the previous embodiments, further comprising:
   providing user data; and
   forwarding the user data to a host computer via the transmission to a base station.

### Group B Embodiments

B1. A method performed by a network node in a communication network, the method comprising:
   receiving a burst of packets from an application server, wherein a Real-time Transport Protocol, RTP, extension header within at least one of the packets in the burst includes information about the burst.
B2. The method of embodiment B1, wherein the packets are Internet Protocol, IP, packets.
B3. The method of any of embodiments B1-B2, wherein the packets each transport an RTP payload.
B4. The method of any of embodiments B1-B3, wherein the packets each transport an RTP packet with an RTP extension header.
B5. The method of any of embodiments B1-B4, wherein the information includes burst size information indicating a size of the burst.
B6. The method of embodiment B5, wherein the burst size information indicates the size of the burst as being a certain number of bytes or as being within a certain byte number range.
B7. The method of embodiment B5, wherein the burst size information indicates the size of the burst by indicating an index into a look-up table or list of different possible burst sizes.
B8. The method of any of embodiments B1-B7, wherein the information includes packet number information indicating a number of the packets in the burst.
B9. The method of any of embodiments B1-B8, wherein the packets in the burst comprise one or more sets of packets, wherein each set of packets includes packets carrying respective parts of the same unit of information from an application layer of the application server.
B10. The method of embodiment B9, wherein the one or more sets of packets are one or more Protocol Data Unit, PDU, sets, wherein each of the packets is a PDU.
B11. The method of any of embodiments B9-B10, wherein the information includes packet set information indicating how many sets of packets are included in the burst.
B12. The method of any of embodiments B9-B11, wherein the information includes packet set information indicating a number of the one or more sets of packets in the burst.
B13. The method of any of embodiments B9-B12, wherein the information includes packet set size information indicating one or more respective sizes of the one or more sets of packets.
B14. The method of any of embodiments B9-B13, wherein the information includes packet set packet number information indicating, for each of the one or more sets of packets, a number of packets in the set.
B15. The method of any of embodiments B9-B14, wherein the information includes packet set generation timing information indicating:
   a difference between times at which successive sets of packets in the burst are generated; or
   a minimum and maximum difference between times at which successive sets of packets in the burst are generated; or
   for each pair of successive sets of packets in the burst, a respective difference between times at which the successive sets of packets are generated; or
B16. The method of any of embodiments B9-B15, wherein the information includes packet set identity information indicating which packets belong to which sets of packets.
B17. The method of any of embodiments B9-B16, wherein the information includes delay budget information indicating, for each of the one or more sets of packets in the burst, a delay budget for the set of packets.
B18. The method of any of embodiments B9-B17, wherein the information includes packet set importance information indicating, for each of the one or more sets of packets, a level of importance of the set of packets.
B19. The method of any of embodiments B1-B18, wherein the information includes burst importance information indicating a level of importance of the burst.
B20. The method of any of embodiments B1-B19, wherein the information includes burst dependence information indicating one or more other bursts of packets on which the burst is dependent.
B21. The method of any of embodiments B1-B20, wherein the packets each carry extended reality, XR, traffic.
B22. The method of any of embodiments B1-B21, wherein receiving the burst of packets comprises receiving the packets back-to-back in a burst time interval.
B23. The method of any of embodiments B1-B22, wherein the information about the burst is included in the RTP extension header within each of the packets in the burst.
B24. The method of any of embodiments B1-B23, wherein the network node implements a User Plane Function, UPF.
B25. The method of any of embodiments B1-B24, wherein the network node is a user plane network node in a core network of the communication network.
B26. The method of any of embodiments B1-B25, further comprising forwarding the packets in the burst.
B27. The method of embodiment B26, wherein forwarding the packets comprises forwarding the packets in the burst to an access network node in an access network of the communication network.
B28. The method of embodiment B27, wherein forwarding the packets comprises transmitting the packets over a user plane tunnel between the network node and the access network node.
B29. The method of embodiment B28, further comprising adding the information to a tunnel extension header of at least one of the forwarded packets.
B30. The method of embodiment B29, wherein the user plane tunnel is a General Packet Radio Service, GPRS, Tunnelling Protocol, GTP, and wherein the tunnel extension header is a GTP user plane extension header.
B31. The method of any of embodiments B29-B30, wherein the tunnel extension header includes a DL PDU SESSION INFORMATION frame, wherein the information is added to one or more fields in the DL PDU SESSION INFORMATION frame.
B32. The method of any of embodiments B29-B30, wherein the tunnel extension header includes a DL USER DATA frame, wherein the information is added to one or more fields in the DL USER DATA frame.
BB1. A method performed by a network node in a communication network, the method comprising:
   transmitting a burst of packets over a user plane tunnel between the network node and an access network node in an access network of the communication network, wherein a tunnel extension header of at least one of the packets in the burst includes information about the burst.
BB2. The method of embodiment BB1, wherein the packets are Internet Protocol, IP, packets.
BB3. The method of any of embodiments BB1-BB2, wherein the packets each transport an RTP payload.
BB4. The method of any of embodiments BB1-BB3, wherein the packets each transport an RTP packet with an RTP extension header.
BB5. The method of any of embodiments BB1-BB4, wherein the information includes burst size information indicating a size of the burst.
BB6. The method of embodiment BB5, wherein the burst size information indicates the size of the burst as being a certain number of bytes or as being within a certain byte number range.
BB7. The method of embodiment BB5, wherein the burst size information indicates the size of the burst by indicating an index into a look-up table or list of different possible burst sizes.
BB8. The method of any of embodiments BB1-BB7, wherein the information includes packet number information indicating a number of the packets in the burst.
BB9. The method of any of embodiments BB1-BB8, wherein the packets in the burst comprise one or more sets of packets, wherein each set of packets includes packets carrying respective parts of the same unit of information from an application layer of the application server.
BB10. The method of embodiment BB9, wherein the one or more sets of packets are one or more Protocol Data Unit, PDU, sets, wherein each of the packets is a PDU.
BB11. The method of any of embodiments BB9-BB10, wherein the information includes packet set information indicating how many sets of packets are included in the burst.
BB12. The method of any of embodiments BB9-BB11, wherein the information includes packet set information indicating a number of the one or more sets of packets in the burst.
BB13. The method of any of embodiments BB9-BB12, wherein the information includes packet set size information indicating one or more respective sizes of the one or more sets of packets.
BB14. The method of any of embodiments BB9-BB13, wherein the information includes packet set packet number information indicating, for each of the one or more sets of packets, a number of packets in the set.
BB15. The method of any of embodiments BB9-BB14, wherein the information includes packet set generation timing information indicating:
   a difference between times at which successive sets of packets in the burst are generated; or
   a minimum and maximum difference between times at which successive sets of packets in the burst are generated; or
   for each pair of successive sets of packets in the burst, a respective difference between times at which the successive sets of packets are generated; or
BB16. The method of any of embodiments BB9-BB15, wherein the information includes packet set identity information indicating which packets belong to which sets of packets.
BB17. The method of any of embodiments BB9-BB16, wherein the information includes delay budget information indicating, for each of the one or more sets of packets in the burst, a delay budget for the set of packets.
BB18. The method of any of embodiments BB9-BB17, wherein the information includes packet set importance information indicating, for each of the one or more sets of packets, a level of importance of the set of packets.
BB19. The method of any of embodiments BB1-BB18, wherein the information includes burst importance information indicating a level of importance of the burst.
BB20. The method of any of embodiments BB1-BB19, wherein the information includes burst dependence information indicating one or more other bursts of packets on which the burst is dependent.
BB21. The method of any of embodiments BB1-BB20, wherein the packets each carry extended reality, XR, traffic.
BB22. The method of any of embodiments BB1-BB21, wherein transmitting the burst of packets comprises transmitting the packets back-to-back in a burst time interval.
BB23. The method of any of embodiments BB1-BB22, wherein the network node implements a User Plane Function, UPF.
BB24. The method of any of embodiments BB1-BB23, wherein the user plane tunnel is a General Packet Radio Service, GPRS, Tunnelling Protocol, GTP, and wherein the tunnel extension header is a GTP user plane extension header.
BB25. The method of any of embodiments BB1-BB24, wherein the tunnel extension header includes a DL PDU SESSION INFORMATION frame, wherein the information is added to one or more fields in the DL PDU SESSION INFORMATION frame.
BB26. The method of any of embodiments BB1-BB24, wherein the tunnel extension header includes a DL USER DATA frame, wherein the information is added to one or more fields in the DL USER DATA frame.
BB. The method of any of the previous embodiments, further comprising:
   obtaining user data; and
   forwarding the user data to a host computer or a communication device.

### Group X Embodiments

X1. A method performed by an access network node in an access network of a communication network, the method comprising:
   receiving a burst of packets over a user plane tunnel between the access network node and a user plane network node in a core network of the communication network, wherein a tunnel extension header of at least one of the packets in the burst includes information about the burst.
X2. The method of embodiment X1, wherein the packets are Internet Protocol, IP, packets.
X3. The method of any of embodiments X1-X2, wherein the packets each transport an RTP payload.
X4. The method of any of embodiments X1-X3, wherein the packets each transport an RTP packet with an RTP extension header.
X5. The method of any of embodiments X1-X4, wherein the information includes burst size information indicating a size of the burst.
X6. The method of embodiment X5, wherein the burst size information indicates the size of the burst as being a certain number of bytes or as being within a certain byte number range.
X7. The method of embodiment X5, wherein the burst size information indicates the size of the burst by indicating an index into a look-up table or list of different possible burst sizes.
X8. The method of any of embodiments X1-X7, wherein the information includes packet number information indicating a number of the packets in the burst.
X9. The method of any of embodiments X1-X8, wherein the packets in the burst comprise one or more sets of packets, wherein each set of packets includes packets carrying respective parts of the same unit of information from an application layer of the application server.
X10. The method of embodiment X9, wherein the one or more sets of packets are one or more Protocol Data Unit, PDU, sets, wherein each of the packets is a PDU.
X11. The method of any of embodiments X9-X10, wherein the information includes packet set information indicating how many sets of packets are included in the burst.
X12. The method of any of embodiments X9-X11, wherein the information includes packet set information indicating a number of the one or more sets of packets in the burst.
X13. The method of any of embodiments X9-X12, wherein the information includes packet set size information indicating one or more respective sizes of the one or more sets of packets.
X14. The method of any of embodiments X9-X13, wherein the information includes packet set packet number information indicating, for each of the one or more sets of packets, a number of packets in the set.
X15. The method of any of embodiments X9-X14, wherein the information includes packet set generation timing information indicating:
   a difference between times at which successive sets of packets in the burst are generated; or
   a minimum and maximum difference between times at which successive sets of packets in the burst are generated; or
   for each pair of successive sets of packets in the burst, a respective difference between times at which the successive sets of packets are generated; or
X16. The method of any of embodiments X9-X15, wherein the information includes packet set identity information indicating which packets belong to which sets of packets.
X17. The method of any of embodiments X9-X16, wherein the information includes delay budget information indicating, for each of the one or more sets of packets in the burst, a delay budget for the set of packets.
X18. The method of any of embodiments X9-X17, wherein the information includes packet set importance information indicating, for each of the one or more sets of packets, a level of importance of the set of packets.
X19. The method of any of embodiments X1-X18, wherein the information includes burst importance information indicating a level of importance of the burst.
X20. The method of any of embodiments X1-X19, wherein the information includes burst dependence information indicating one or more other bursts of packets on which the burst is dependent.
X21. The method of any of embodiments X1-X20, wherein the packets each carry extended reality, XR, traffic.
X22. The method of any of embodiments X1-X21, wherein receiving the burst of packets comprises receiving the packets back-to-back in a burst time interval.
X23. The method of any of embodiments X1-X22, wherein the network node implements a User Plane Function, UPF.
X24. The method of any of embodiments X1-X23, wherein the user plane tunnel is a General Packet Radio Service, GPRS, Tunnelling Protocol, GTP, and wherein the tunnel extension header is a GTP user plane extension header.
X25. The method of any of embodiments X1-X24, wherein the tunnel extension header includes a DL PDU SESSION INFORMATION frame, wherein the information is added to one or more fields in the DL PDU SESSION INFORMATION frame.
X26. The method of any of embodiments X1-X24, wherein the tunnel extension header includes a DL USER DATA frame, wherein the information is added to one or more fields in the DL USER DATA frame.
X27. The method of any of embodiments X1-X26, further comprising, based on the information, allocating radio resources for transmitting the burst of packets over an access link.
X28. The method of embodiment X27, wherein said allocating comprises allocating radio resources based on how many packets are included in the burst and/or based on how many sets of packets are included in the burst.
X29. The method of any of embodiments X1-X28, further comprising transmitting the burst of packets over an access link.

### Group C Embodiments

C1. An application server configured to perform any of the steps of any of the Group A embodiments.
C2. An application server comprising processing circuitry configured to perform any of the steps of any of the Group A embodiments.
C3. An application server comprising:
   communication circuitry; and
   processing circuitry configured to perform any of the steps of any of the Group A embodiments.
C4. An application server comprising:
   processing circuitry configured to perform any of the steps of any of the Group A embodiments; and
   power supply circuitry configured to supply power to the application server.
C5. An application server comprising:
   processing circuitry and memory, the memory containing instructions executable by the processing circuitry whereby the application server is configured to perform any of the steps of any of the Group A embodiments.
C6. Reserved
C7. Reserved
C8. A computer program comprising instructions which, when executed by at least one processor of an application server, causes the application server to carry out the steps of any of the Group A embodiments.
C9. A carrier containing the computer program of embodiment C7, wherein the carrier is one of an electronic signal, optical signal, radio signal, or computer readable storage medium.
C10. A network node configured to perform any of the steps of any of the Group B embodiments.
C11. A network node comprising processing circuitry configured to perform any of the steps of any of the Group B embodiments.
C12. A network node comprising:
   communication circuitry; and
   processing circuitry configured to perform any of the steps of any of the Group B embodiments.
C13. A network node comprising:
   processing circuitry configured to perform any of the steps of any of the Group B embodiments;
   power supply circuitry configured to supply power to the network node.
C14. A network node comprising:
   processing circuitry and memory, the memory containing instructions executable by the processing circuitry whereby the network node is configured to perform any of the steps of any of the Group B embodiments.
C15. The network node of any of embodiments C10-C14, wherein the network node is a user plane network node in a core network.
C16. A computer program comprising instructions which, when executed by at least one processor of a network node, causes the network node to carry out the steps of any of the Group B embodiments.
C17. The computer program of embodiment C16, wherein the network node is a user plane network node in a core network.
C18. A carrier containing the computer program of any of embodiments C16-C17, wherein the carrier is one of an electronic signal, optical signal, radio signal, or computer readable storage medium.
C19. An access network node configured to perform any of the steps of any of the Group X embodiments.
C20. An access network node comprising processing circuitry configured to perform any of the steps of any of the Group X embodiments.
C21. An access network node comprising:
   communication circuitry; and
   processing circuitry configured to perform any of the steps of any of the Group X embodiments.
C22. An access network node comprising:
   processing circuitry configured to perform any of the steps of any of the Group X embodiments;
   power supply circuitry configured to supply power to the access network node.
C23. An access network node comprising:
   processing circuitry and memory, the memory containing instructions executable by the processing circuitry whereby the access network node is configured to perform any of the steps of any of the Group X embodiments.
C24. The access network node of any of embodiments C19-C23, wherein the access network node is a base station.
C25. A computer program comprising instructions which, when executed by at least one processor of an access network node, causes the access network node to carry out the steps of any of the Group X embodiments.
C26. The computer program of embodiment C25, wherein the access network node is a base station.
C27. A carrier containing the computer program of any of embodiments C25-C26, wherein the carrier is one of an electronic signal, optical signal, radio signal, or computer readable storage medium.

### REFERENCES

1. 3GPP, TR 23.700-60 V0.3.0, (2022-02) Study on XR (Extended Reality) and media services (Release 18)
2. RFC 3550: RTP: A Transport Protocol for Real-Time Applications (rfc-editor.org)
3. TS 38.415 V17.0.0, PDU Session User Plane Protocol (Release 17)
4. TS 38.425 V17.0.0, NR user plane protocol
5. TS 23.502, System architecture for the 5G system, Section 5.7, v17.4.0 (2022)

1.-66. (canceled)

67. A method performed by an access network node in an access network of a communication network, the method comprising:
receiving a burst of packets over a user plane tunnel between the access network node and a user plane network node in a core network of the communication network;
wherein a tunnel extension header of at least one of the packets in the burst includes information about the burst;
wherein the packets in the burst comprise one or more sets of packets, wherein each set of packets includes packets carrying respective parts of the same unit of information from an application layer of the application server;
wherein the information includes packet set generation timing information indicating one of:
a difference between times at which successive sets of packets in the burst are generated;
a minimum and maximum difference between times at which successive sets of packets in the burst are generated; and
for each pair of successive sets of packets in the burst, a respective difference between times at which the successive sets of packets are generated.

68. The method of claim 67, wherein the packets are Internet Protocol (IP) packets, and wherein the packets each transport a Real-Time Transport Protocol (RTP) packet with an RTP extension header.

69. The method of claim 67, wherein the user plane tunnel is a General Packet Radio Service (GPRS) Tunnelling Protocol (GTP), and wherein the tunnel extension header is a GTP user plane extension header.

70. The method of claim 67, wherein the tunnel extension header includes:
a DL PDU SESSION INFORMATION frame, wherein the information is added to one or more fields in the DL PDU SESSION INFORMATION frame; or
a DL USER DATA frame, wherein the information is added to one or more fields in the DL USER DATA frame.

71. The method of claim 67, wherein the information includes:
burst size information indicating a size of the burst; and/or
packet number information indicating a number of the packets in the burst.

72. The method of claim 67, wherein the one or more sets of packets are one or more Protocol Data Unit (PDU) sets, wherein each of the packets is a PDU.

73. The method of claim 67, wherein the information includes packet set information indicating:
how many sets of packets are included in the burst; and/or
a number of the one or more sets of packets in the burst.

74. The method of claim 67, wherein the information includes:
packet set size information indicating one or more respective sizes of the one or more sets of packets; and/or
packet set packet number information indicating, for each of the one or more sets of packets, a number of packets in the set.

75. The method of claim 67, wherein the information includes:
packet set identity information indicating which packets belong to which sets of packets;
delay budget information indicating, for each of the one or more sets of packets in the burst, a delay budget for the set of packets; and/or
packet set importance information indicating, for each of the one or more sets of packets, a level of importance of the set of packets.

76. The method of claim 67, wherein the information includes:
burst importance information indicating a level of importance of the burst; and/or
burst dependence information indicating one or more other bursts of packets on which the burst is dependent.

77. A method performed by a network node in a communication network, the method comprising:
transmitting or receiving a burst of packets over a user plane tunnel between the network node and an access network node in an access network of the communication network;
wherein a tunnel extension header of at least one of the packets in the burst includes information about the burst;
wherein the packets in the burst comprise one or more sets of packets, wherein each set of packets includes packets carrying respective parts of the same unit of information from an application layer of the application server;
wherein the information includes packet set generation timing information indicating one of:
a difference between times at which successive sets of packets in the burst are generated;
a minimum and maximum difference between times at which successive sets of packets in the burst are generated; and
for each pair of successive sets of packets in the burst, a respective difference between times at which the successive sets of packets are generated.

78. The method of claim 77, wherein the packets are Internet Protocol (IP) packets, and wherein the packets each transport a Real-Time Transport Protocol (RTP) packet with an RTP extension header.

79. The method of claim 77, wherein the user plane tunnel is a General Packet Radio Service (GPRS) Tunnelling Protocol (GTP), and wherein the tunnel extension header is a GTP user plane extension header.

80. The method of claim 77, wherein the tunnel extension header includes:
a DL PDU SESSION INFORMATION frame, wherein the information is added to one or more fields in the DL PDU SESSION INFORMATION frame; or
a DL USER DATA frame, wherein the information is added to one or more fields in the DL USER DATA frame.

81. The method of claim 77, wherein the information includes:
burst size information indicating a size of the burst; and/or
packet number information indicating a number of the packets in the burst.

82. The method of claim 77, wherein the one or more sets of packets are one or more Protocol Data Unit (PDU) sets, wherein each of the packets is a PDU.

83. The method of claim 77, wherein the information includes packet set information indicating:
how many sets of packets are included in the burst; and/or
a number of the one or more sets of packets in the burst.

84. The method of claim 77, wherein the information includes:
packet set size information indicating one or more respective sizes of the one or more sets of packets; and/or
packet set packet number information indicating, for each of the one or more sets of packets, a number of packets in the set.

85. The method of claim 77, further comprising:
receiving the burst of packets from an application server, wherein a Real-time Transport Protocol (RTP) extension header within at least one of the packets in the burst includes the information about the burst;
extracting the information about the burst from the RTP extension header; and
adding the extracted information to the tunnel extension header of the at least one of the packets in the burst to be transmitted over the user plane tunnel.

86. An access network node configured for use in an access network of a communication network, the access network node comprising:
communication circuitry; and
processing circuitry configured to receive a burst of packets over a user plane tunnel between the access network node and a user plane network node in a core network of the communication network;
wherein a tunnel extension header of at least one of the packets in the burst includes information about the burst;
wherein the packets in the burst comprise one or more sets of packets, wherein each set of packets includes packets carrying respective parts of the same unit of information from an application layer of the application server;
wherein the information includes packet set generation timing information indicating one of:
a difference between times at which successive sets of packets in the burst are generated;
a minimum and maximum difference between times at which successive sets of packets in the burst are generated; and
for each pair of successive sets of packets in the burst, a respective difference between times at which the successive sets of packets are generated.

87. A network node configured for use in a communication network, the network node comprising:
communication circuitry; and
processing circuitry configured to transmit or receive a burst of packets over a user plane tunnel between the network node and an access network node in an access network of the communication network;
wherein a tunnel extension header of at least one of the packets in the burst includes information about the burst;
wherein the packets in the burst comprise one or more sets of packets, wherein each set of packets includes packets carrying respective parts of the same unit of information from an application layer of the application server;
wherein the information includes packet set generation timing information indicating one of:
a difference between times at which successive sets of packets in the burst are generated;
a minimum and maximum difference between times at which successive sets of packets in the burst are generated; and
for each pair of successive sets of packets in the burst, a respective difference between times at which the successive sets of packets are generated.
